(19) United States
(12) Patent Application Publication
(10) Pub. No.: US 2017/0039868 A1
(43) Pub. Date: Feb. 9, 2017

(54) INFORMATION PROCESSING APPARATUS AND ABILITY IMPROVEMENT ASSISTING METHOD

(71) Applicant: Renesas Electronics Corporation, Tokyo (JP)

(72) Inventor: Shunsuke OKUMURA, Tokyo (JP)

(73) Assignee: Renesas Electronics Corporation, Tokyo (JP)

(21) Appl. No.: 15/178,836

(22) Filed: Jun. 10, 2016

(30) Foreign Application Priority Data
Aug. 5, 2015 (JP) 2015-154924

(51) Int. Cl. G09B 5/12; G09B 19/00; G09B 5/14

(52) U.S. Cl. CPC G09B 5/12; G09B 5/14; G09B 19/00

(57) ABSTRACT

An information processing apparatus is provided including: a storing unit storing state transition information in which at least one ability improving method executed by a plurality of registered users and a combination of transitions of ability states of the plurality of registered users by execution of at least a part of the ability improving method are associated; a selecting unit selecting, from the state transition information, at least one second ability state which is an after-transition state from a first ability state in atrial user aiming at reaching a desired ability state and can be a pass point to the desired ability state; and a generating unit generating between-ability-state relative position information including a relative position relation using the first ability state as a reference and the associated ability improving method for each of the selected at least one second ability state.

### CROSS-REFERENCE TO RELATED APPLICATIONS

The disclosure of Japanese Patent Application No. 2015-154924 filed on Aug. 5, 2015 including the specification, drawings and abstract is incorporated herein by reference in its entirety.

### BACKGROUND

The present invention relates to an information processing apparatus and an ability improvement assisting method and, for example, relates to an information processing apparatus and an ability improvement assisting method for assisting ability of an individual such as exercise and knowledge.

Patent Literature 1 discloses a technique related to a movement training display system presenting a training plan suited for an individual. The movement training display system visually displays the difference between actual movement of the user and a model movement, retrieves a corresponding training plan on the basis of the difference from a database, and displays the training plan.

Patent Literature 2 discloses a technique related to an education attendance navigation system displaying an education/training curriculum which is important to a student. In the education attendance navigation system, on the basis of weighted information associated with a combination of attribute information of an individual and training information, at least one education/training curriculum recommended to each student is extracted and displayed together with the degree of importance corresponding to the weighted information.

### RELATED ART LITERATURE

### Patent Literature

Patent Literature 1
Japanese Unexamined Patent Application Publication No. 2005-111178
Patent Literature 2
Japanese Unexamined Patent Application Publication No. 2006-133443

### SUMMARY

However, the techniques disclosed in the patent literatures 1 and 2 have a problem that the user cannot grasp the process of improving his/her ability and there is a case that it is difficult to maintain motivation of executing a training method or the like for improving ability (ability improving method). The reason is that, only by presentation of the ability improving method, it is not easy for the user to grasp the relation between the process of improving his/her ability and the ability improving method.

The other objects and novel features will become apparent from the description of the specification and the appended drawings.

According to an embodiment, an information processing apparatus generates information including a relative position relation of an ability state of another user whose ability was improved in the past from an ability state of a certain user using the ability state of the certain user as a reference and an ability improving method executed at the time of improvement.

According to the embodiment, the user can grasp the process of improving his/her ability, and maintenance of motivation of executing the ability improving method can be assisted.

### BRIEF DESCRIPTION OF THE DRAWINGS

FIG. 1 is a block diagram illustrating a configuration example of an information processing apparatus 1 according to a first embodiment.

FIG. 2 is a diagram for explaining the concept of a between-ability-state relative position information 160 in the first embodiment.

FIG. 3 is a block diagram illustrating a hardware configuration example of the information processing apparatus 1 according to the first embodiment.

FIG. 4 is a block diagram illustrating a configuration example of an information processing apparatus 1a according to a second embodiment.

FIG. 5 is a diagram for explaining the concept of between-ability-state relative position information 160a in the second embodiment.

FIG. 6 is a block diagram illustrating a configuration example of a system including an advice presentation server 3 according to Example 1 of a third embodiment.

FIG. 7 is a diagram illustrating an example of registration data in a training database 301.

FIG. 8 is a diagram illustrating an example of registration data in an item evaluation table 302.

FIG. 9 is a diagram illustrating an example of registration data in a classification table 303.

FIG. 10 is a diagram illustrating an example of registration data in a score conversion table 304.

FIG. 11 is a diagram illustrating an example of a between-class transition table 305.

FIG. 12 is a diagram illustrating an example of an advice graph 23.

FIG. 13 is a flowchart describing the flow of advice presenting process in Example 1 of the third embodiment.

FIG. 14 is a flowchart describing the flow of a transition relation generating process in Example 1 of the third embodiment.

FIG. 15 is a diagram illustrating an example of scores of a user B1 and initial coordinates.

FIG. 16 is a diagram illustrating an example of the positional relations between a (present) ability state of the user B1 and ability states as a plurality of goals.

FIG. 17 is a diagram for explaining the concept of calculation of coordinates of a class after transition.

FIG. 18 is a diagram for explaining the concept of calculation of coordinates of a class after transition.

FIG. 19 is a diagram illustrating an example of the advice graph 23.

FIG. 20 is a diagram for explaining the concept of process of registering trainings and performances.

FIG. 21 is a diagram for explaining the details of an ability class of a user before and after a training and details of the training executed.

FIG. 22 is a diagram illustrating an example of a result of plotting a plurality of transitions onto an advice graph.

FIG. 23 is a diagram illustrating an example of coupling records of a plurality of users.

FIG. 24 is a diagram illustrating an example of presenting a plurality of training methods.

FIG. 25 is a diagram illustrating data of two paths to reach two target class candidates.

FIG. 26 is a diagram illustrating an example of relations between measurement values of pitching forms and postures at respective times.

FIG. 27 is a diagram illustrating an example of changes in time of coordinates of balls and evaluation values by pitch types.

FIG. 28 is a diagram illustrating an example of presentation orders of training plans when priority is placed on required time.

FIG. 29 is a diagram illustrating a display example of an advice graph when priority is placed on required time.

FIG. 30 is a diagram illustrating an example of presentation orders of training plans when priority is placed on the difficulty level.

FIG. 31 is a diagram illustrating a display example of an advice graph when priority is placed on the difficulty level.

FIG. 32 is a flowchart illustrating the flow of neighborhood class retrieving process according to a fifth embodiment.

FIG. 33 is a diagram for explaining the concept of a neighborhood class coupling method.

FIG. 34 is a diagram illustrating an example of an advice graph for four ranges by physical characteristic.

FIG. 35 is a diagram illustrating an example of an item evaluation table and a classification table after integration of Example 5-1 according to a seventh embodiment.

FIG. 36 is a diagram illustrating an example of the item evaluation table and the classification table after integration of Example 5-2 according to the seventh embodiment.

FIG. 37 is a diagram for explaining the concept in a class integration state according to the seventh embodiment and a detailed classification state according to an eighth embodiment.

### DETAILED DESCRIPTION

Hereinafter, concrete embodiments to which means for solving the above-described problems is applied will be described in detail with reference to the drawings. In each of the drawings, the same reference numerals are designated to the same elements and, for clarification of explanation, repetitive description will not be given as necessary.

In the following embodiments, when necessary for convenience, an embodiment will be described by being divided to a plurality of sections or examples. Unless otherwise clearly specified, they are not non-related but have relations such as modification, application example, detailed description, and supplementary explanation in which one is a part or all of the other. In the following embodiment, in the case of mentioning the number of elements and the like (including the number of pieces, numerical value, quantity, and range), except for the case where it is clearly mentioned, the case where the invention is principally clearly limited to a specific value, and the like, the invention is not limited to the specific value. The number may be larger or smaller than the specific value.

Further, in the following embodiments, components (including operation steps) are not always necessary except for the case where it is clearly mentioned, the case where it is considered that a component is principally clearly necessary, and the like. Similarly, in the following embodiments, when shape, position relation, and the like of components are mentioned, they substantially include shape and the like close or similar to them except for the case where it is clearly mentioned, the case where it is considered that the shape and the like are not principally clearly similar. The number and the like (including the number of pieces, numerical value, quantity, and range) are also similar to the above.

The circumstances that the following embodiments have been reached will be described. First, to improve ability of sports, study, or the like to a level at which a predetermined goal can be achieved, a training method (ability improving method) such as exercise or learning has to be executed. There is, however, a case that it is difficult for the user to select a training method or the like suitable to the user himself/herself. The cause is that, first, it is difficult to accurately grasp the level of presently-obtained ability of the user himself/herself and the level of the ability after achieving the goal. In addition, there are various kinds, orders, combinations, and the like of training methods for achieving a predetermined goal. The time which can be assured for improvement in the ability, an allowable period, cost, motivation, and the like vary among users, and a selection criterion varies for a plurality of training method and the like.

Generally, there are a plurality of training methods which can reach an ability state of achieving a goal. For example, for a goal of shortening completion run time of a full marathon from five hours and more to four hours or less, a plurality of training methods such as dash and improvement of core strength exist and have different characteristics such as difficulty level and required period. Consequently, only one index such as weighting is insufficient as an index for selection for each of users to compare the differences in the training methods.

In the case of thinking training records of another user who already achieved the goal the user aims as a reference, it is said that trainings executed from the ability level equivalent to the ability level of the user at present to goal achievement are more suitable to the need. When a plurality of users who already achieved the goal the user aims exit, the ability levels after goal achievement of the users are not always equal. That is, there are variations in the abilities of users after goal achievement and a different method and a different period are necessary to reach the ability level of each user.

Consequently, for selection of a proper training method by which the user achieves the goal and which satisfies needs (characteristics and preferences) of the user, it is important to present the relation between the ability levels after goal achievement in a plurality of users who already achieved the goal and training methods required to reach the ability levels.

Even if the ability levels of users after achieving the same goal are equal, it is also considered that ability levels and abilities shifted to reach the ability level vary among the users. That is, there is a case that the users in the same ability state may have different ability states to achieve the goal due to the differences in trainings executed and differences in effects of the trainings due to individual difference. It is therefore very important that, by presenting transition of a plurality of ability states assumed to achieve a goal and a plurality of trainings necessary in the respective states to the user, the user understands a realization method required to achieve the goal, difficulty, accumulation of effects of trainings of the user, and the like from a higher perspective, and the possibility of goal realization is increased.

Embodiments for achieving the object will be described below.

### First Embodiment

A first embodiment relates to a technique, when a certain user (trial user) tries to execute any ability improving method to improve his/her ability, of assisting selection of an ability improving method to be executed by the user by presenting transition in the case where another user (registered user) executed at least a part of a plurality of ability improving methods and the ability state equivalent to that of the trial user changes.

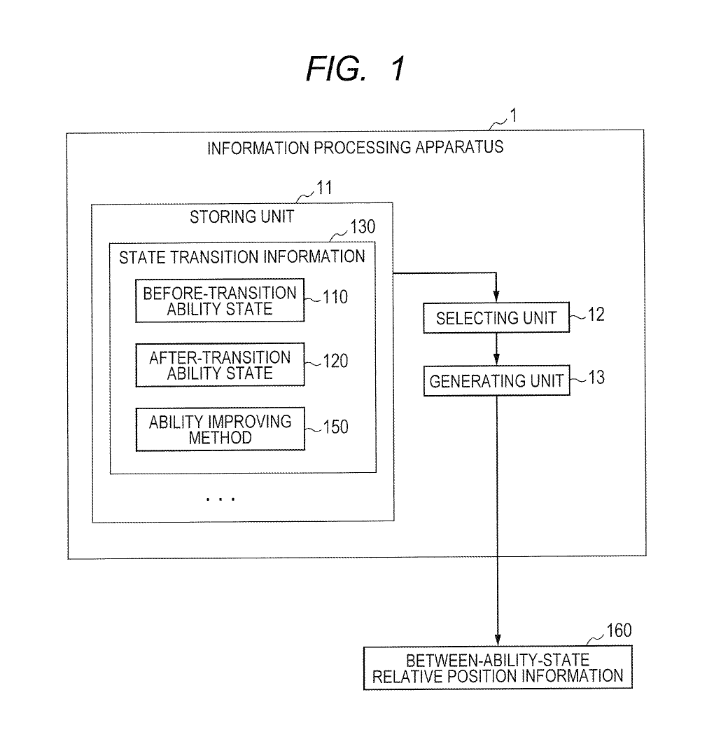

FIG. 1 is a block diagram illustrating a configuration example of an information processing apparatus 1 according to a first embodiment. The information processing apparatus 1 includes a storing unit 11, a selecting unit 12, and a generating unit 13. The storing unit 11 is a storage device storing state transition information 130. The state transition information 130 is information in which a combination of a before-transition ability state 110 and an after-transition ability state 120 in a registered user is associated with an ability improving method 150 executed by the registered user in transition from the before-transition ability state 110 to the after-transition ability state 120. It can be also said that the state transition information 130 is information in which at least one of ability improving methods executed by a plurality of registered users and a combination of transitions in ability states of the plurality of registered users made by execution of at least a part of the ability improving methods are associated.

The before-transition ability state 110 is information indicating a state of ability before execution of an ability improving method in a registered user. The after-transition ability state 120 is information indicating an ability state after execution of at least a part of a plurality of ability improving methods by a registered user. It can be therefore also said that the combination of the before-transition ability state 110 and the after-transition ability state 120 is a combination of an ability state before a transition and the ability state after the transition when a plurality of ability states indicating states of the ability of a registered user change by execution of at least a part of a plurality of ability improving methods by the registered user. Although FIG. 1 illustrates an example that one piece of state transition information 130 includes one before-transition ability state 110, one after-transition ability state 120, and one ability improving method 150, the number of each component may be two or more. It is assumed that the number of pieces of state transition information 130 is two or more.

The “ability improving method” is, for example, a training method for improving the athletic performance of a user or a method of acquiring knowledge or skill (such as attendance in a training class in a classroom or learning for a qualification examination). The registered user may be a virtual user who does not actually execute the ability improving method. Consequently, the after-transition ability state 120 may be a virtual ability state after execution of an ability improving method which is assumed by a trainer or the like.

It is assumed that the after-transition ability state 120 includes an ability state after achievement of a predetermined goal in a trial user and a state in the course to the achievement of the goal. Consequently, when a goal is achievement to a desired ability state and the after-transition ability state 120 is a state in the course to the achievement of the goal, it can be said that the after-transition ability state 120 is an ability state which can be further changed to the desired ability state or that the after-transition ability state 120 includes an ability state which can be a pass point to the desired ability state.

The selecting unit 12 selects, from the state transition information 130, at least one second ability state which is changed from a first ability state as a before-transition ability state corresponding to an ability state of a trial user aiming to reach a desired ability state and can be further changed to a desired ability state. For example, first, the selecting unit 12 selects an ability state corresponding to an ability state of a trial user from the state transition information 130. The selected ability state is called a first ability state. Subsequently, the selecting unit 12 specifies a combination using the first ability state as a before-transition ability state from the state transition information 130 and selects the after-transition ability state 120 as an after-transition ability state in the combination. The selected after-transition ability state 120 is called a second ability state.

The word “corresponding” includes, for example, matching and approximation. A concrete approximation method will be described later. The “desired ability state” is not necessarily apart of ability states stored in the storing unit 11. A trial user “aiming to reach a desired ability state” may designate a desired ability state directly or indirectly. The second ability state is an ability state which can be further changed to the desired ability state. Consequently, for example, the selecting unit 12 checks if there is a combination of the second ability state as the before-transition ability state and the desired ability state as the after-transition ability state in the state transition information 130. Alternatively, information indicating a transition to a desired ability state may be added in advance to a part of the after-transition ability state 120.

For each of at least one second ability state selected by the selecting unit 12, the generating unit 13 generates between-ability-state relative position information 160 including a relative position relation using a first ability state as a reference and an ability improving method associated with the combination of the first ability state and the selected second ability state.

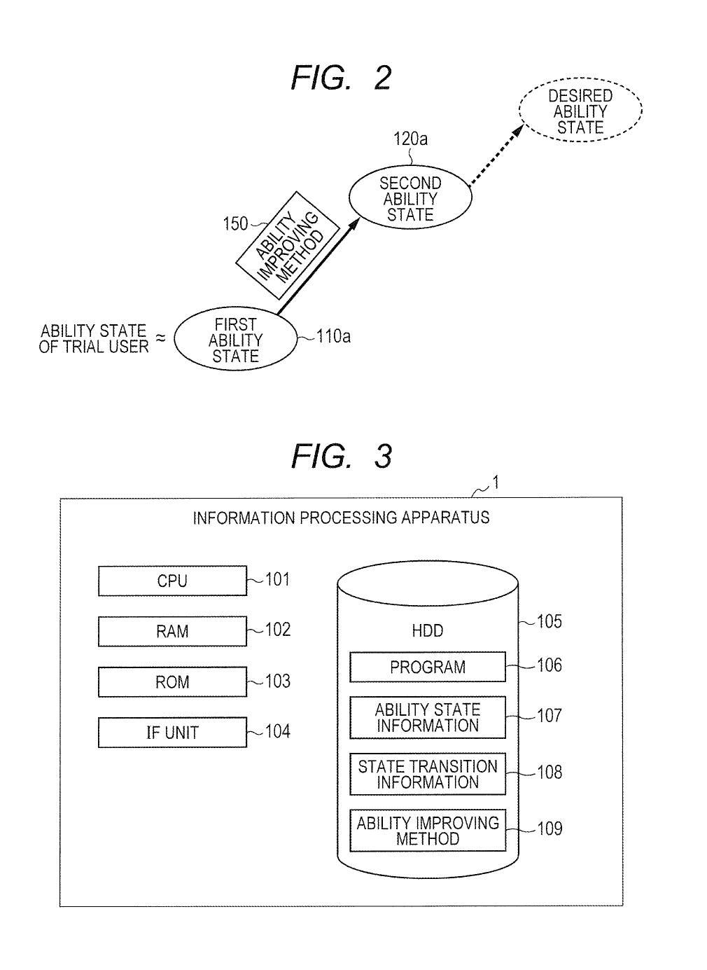

FIG. 2 is a diagram for explaining the concept of the between-ability-state relative position information 160 in the first embodiment. Specifically, the between-ability-state relative position information 160 has an aspect for indicating, by regarding an ability state of a trial user as the before-transition ability state 110 (a first ability state 110a) of a registered user before execution of an ability improving method 150, the after-transition ability state 120 (a second ability state 120a) changed from the before-transition ability state 110 by execution of the ability improving method 150 by the registered user in a relative position relation using the first ability state 110a as a reference. It can be said that the second ability state 120a indicates a pass point in transition to a desired ability state 170 for the trial user. Consequently, the trial user can grasp a process of improving his/her ability from the first ability state 110a to the desired ability state 170 via the second ability state 120a by executing the ability improving method 150. Therefore, the trial user can maintain the motivation to execute the ability improving method 150 by the between-ability-state relative position information 160.

For example, when a goal aimed by a trial user is a “famous athlete”, the first embodiment is beneficial. In this case, the number of desired ability states is one. It is not realistic that an ordinary person reaches the desired ability state by one state transition by a training method. Consequently, according to the first embodiment, by generating the between-ability-state relative position information 160 for specifying a process to reach the desired ability state and presenting the between-ability-state relative position information 160 to the trial user, the trial user can execute the ability improving method with an awareness of the ability state of the “famous athlete” while maintaining the motivation.

FIG. 3 is a block diagram illustrating a hardware configuration example of the information processing apparatus 1 according to the first embodiment. The information processing apparatus 1 can be realized by, for example, a general computer system. The information processing apparatus 1 includes, for example, a control device such as a CPU (Central Processing Unit) 101, memories such as a RAM (Random Access Memory) 102 and a ROM (Read Only Memory) 103, an IF (InterFace) unit 104, and an HDD (Hard Disk Drive) 105. The information processing apparatus 1 may have, as other not-illustrated components, input devices such as a keyboard and a mouse and a display device. The IF unit 104 is an interface for transmitting/receiving data to/from the outside via the input device, the display device, and a network.

In the HDD 105, an OS (Operating System) (not illustrated), a program 106, ability state information 107, state transition information 108, and an ability improving method 109 are stored. The program 106 is a computer program in which processes related to the first embodiment are implemented. The ability state information 107 corresponds to the above-described ability states, that is, the before-transition ability state 110, the after-transition ability state 120, and the like, the state transition information 108 corresponds to the state transition information 130, and the ability improving method 109 corresponds to the above-described ability improving method 150.

The CPU 101 controls various processes in the information processing apparatus 1, accesses to the RAM 102, the ROM 103, the IF unit 104, and the HDD 105, and the like. The information processing apparatus 1 reads and executes the OS and the program 106 stored in the HDD 105 by the CPU 101. By the execution, the information processing apparatus 1 realizes the processes related to the first embodiment.

### Second Embodiment

In a second embodiment, when a user tries to achieve a predetermined goal, it is assisted to select a proper training method matched to the need of the user from a plurality of training methods executed to achieve the goal by a plurality of users already achieved (or expected to achieve) the same goal. The second embodiment can be realized independent of the first embodiment or in combination with the first embodiment.

In this case, “a predetermined goal” denotes, for example, an overall record in a specific athletic event, a threshold or a boundary condition of the record, a proficiency level in a specific study, the name of a professional athlete, an ability level corresponding to the athlete, and the like. Concrete examples are completion time of a full marathon, a pitching form in baseball or acquisition of a specific breaking ball, score of a specific subject, an acquisition level of knowledge or skill by attendance of a training, a passing score of a paper test, and the like. However, the predetermined goal is not limited to the examples.

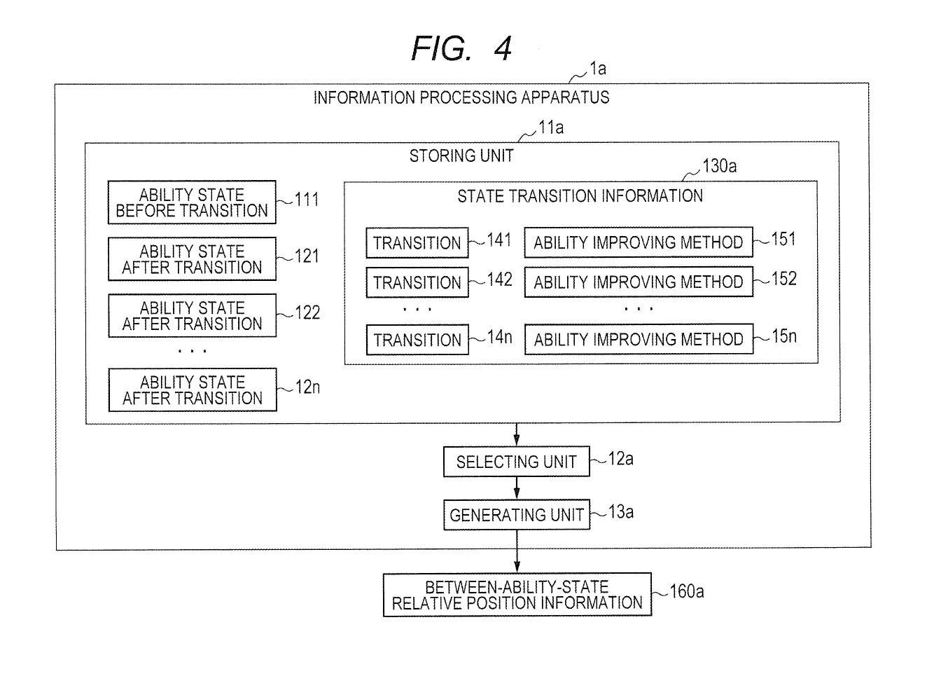

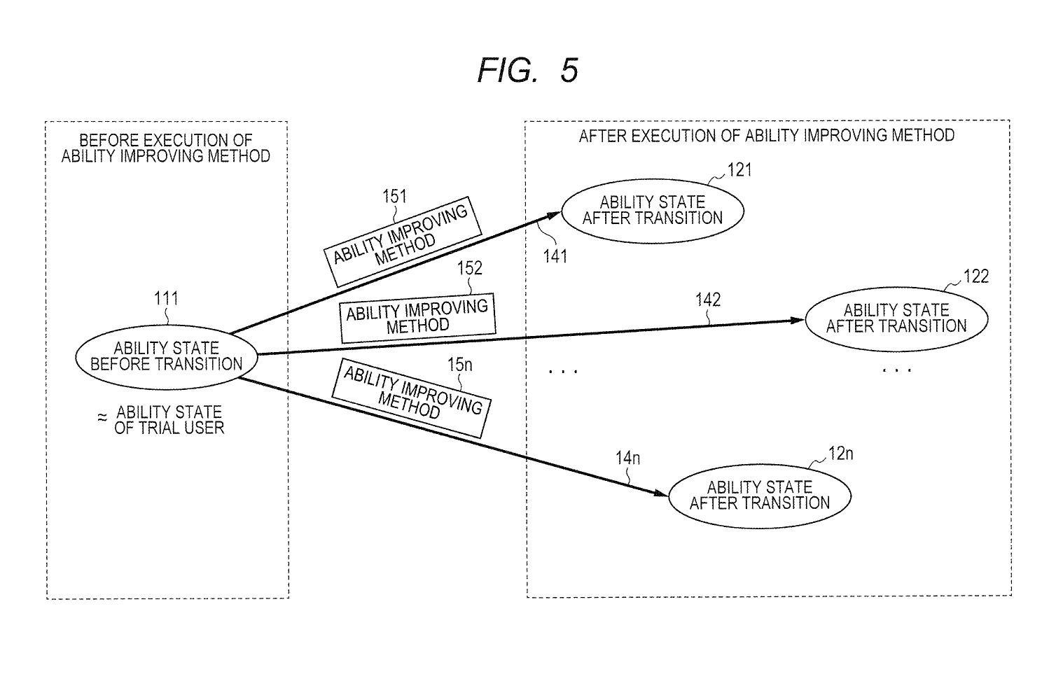

FIG. 4 is a block diagram illustrating a configuration example of an information processing apparatus 1a according to the second embodiment. The information processing apparatus 1a has a storing unit 11a, a selecting unit 12a, and a generating unit 13a. The storing unit 11a is a storing device storing an ability state 111 before transition, a plurality of ability states 121, 122, . . . , and 12n (n is a natural number of two or larger) after transition, and state transition information 130a. The ability state 111 before transition is information corresponding to the state of ability of a trail user. The meaning of the word “corresponding” is the same as that in the first embodiment.

The “state of ability (ability state)” is information indicating the ability of a user for a specific goal and a set of indication values in a plurality of indices related to the goal. The set of the indication values is a set of records of breakdowns in records of the goal, a set of records of other events related to a target event, or the like. For example, when a goal is set to four hours or less of completion time of a full marathon, a set of records of breakdowns in the target record is a set of times at intermediate points (around 10 km and 30 km) or the like. In the case of a similar goal, a set of records of other events related to a target event is, for example, basic physical performances related to a full marathon (a set of records of standing broad jump, push-up, 50-m run, and 20-km run), athletic performances (a set of records of grip strength and the like), and so on. Examples of the ability states are not limited to the above. By defining the ability states as described above, the differences of the abilities of users regarded to have similar abilities in broad sense can be comprehensively and objectively determined from a plurality of viewpoints. Consequently, the abilities of users can be accurately grasped. In the case of the first embodiment, it can be said that the desired ability state corresponds to any of a plurality of ability states aimed by a trial user to achieve a predetermined goal.

The ability state 121 after transition and the like is information indicating the state of ability by which a predetermined goal can be achieved in the case where each of a plurality of registered users executes at least a part of a plurality of ability improving methods 151 and the like. In the explanation of the second embodiment, it is assumed that each of a plurality of registered users achieves independently an ability state after transition from a common ability state before transition by executing any ability improving method. It is assumed that each of the ability states 121 after transition is equivalent to the after-transition ability state 120 and that the plurality of registered users experience the before-transition ability state at least in the past.

When a goal is a threshold in a specific index, an ability state is a set of a plurality of index values as a breakdown of a specific index. Consequently, the difference between ability states of even users having equivalent abilities by which a goal can be achieved can be discriminated, and a user can select an ability improving method by setting a user closer to a his/her aimed direction as a target.

The state transition information 130a is information in which a plurality of transitions 141, 142, . . . , and 14n and a plurality of ability improving methods 151, 152, . . . , and 15n related to the transitions are associated. The “plurality of transitions” denotes information indicating state transitions from the ability state 111 before transition to the plurality of ability states 121 after transition and the like. In other words, it is information in which an ability state before transition is the ability state 111 before transition and an ability state after transition is any of the ability states 121 after transition and the like.

The selecting unit 12a selects at least two ability states after transition associated with the ability state 111 before transition on the basis of the state transition information 130a. Particularly, on the basis of the state transition information 130a, the electing unit 12a may select at least two ability states 121 after transition and the like as after-transition ability states when the ability state of a trial user is the ability state 111 before transition. The generating unit 13a generates between-ability-state relative position information 160a including a relative position relation in the case of using, as a reference, the ability state 111 before transition between at least two ability states 121 after transition and the like selected by the selecting unit 12a, the transitions 141 and the like of the selected after-transition ability states 121 and the like from the ability state 111 before transition, and the ability improving method 151 and the like associated with the transitions. The selecting unit 12 in the above-described first embodiment may select two or more after-transition ability states and the generating unit 13 may generate between-ability-state relative position information including, as a relative position relation, the difference between the selected two or more after-transition ability states. In the second embodiment, the selecting unit 12a is not essential. In this case, the generating unit 13a refers to the state transition information 130a in the storing unit 11a and, when the ability state of a trial user corresponds to the ability state 111 before transition, generates the between-ability-state relative position information 160a including a relative position relation of each of the plurality of after-transition ability states 121 to 12n using the ability state 111 before transition as a reference and an ability improving method associated.

FIG. 5 is a diagram for explaining the concept of the between-ability-state relative position information 160a in the second embodiment. Specifically, by regarding the ability state of a trial user before execution of an ability improving method as the ability state 111 before transition of a registered user, the differences in the abilities among the plurality of ability states 121 to 12n after transition which are achieved (or can be achieved) (selected) by a plurality of registered users are presented in advance as relative position relations using the ability state 111 before transition as a reference, and transitions and different ability improving methods corresponding to the transitions can be presented. Consequently, as compared with presentation of information of the same quality such as the importance level as described in, for example, the patent literature 2, the qualitative differences in the plurality of ability improving methods can be presented so that selection according to the need of the user can be facilitated.

Since the hardware configuration example of the information processing apparatus 1a according to the second embodiment is similar to that illustrated in FIG. 3, its illustration and description are not repeated.

### Third Embodiment

In a third embodiment, concrete examples for realizing the first embodiment and/or the second embodiment will be described.

### Example 1

### Advice Presentation Server

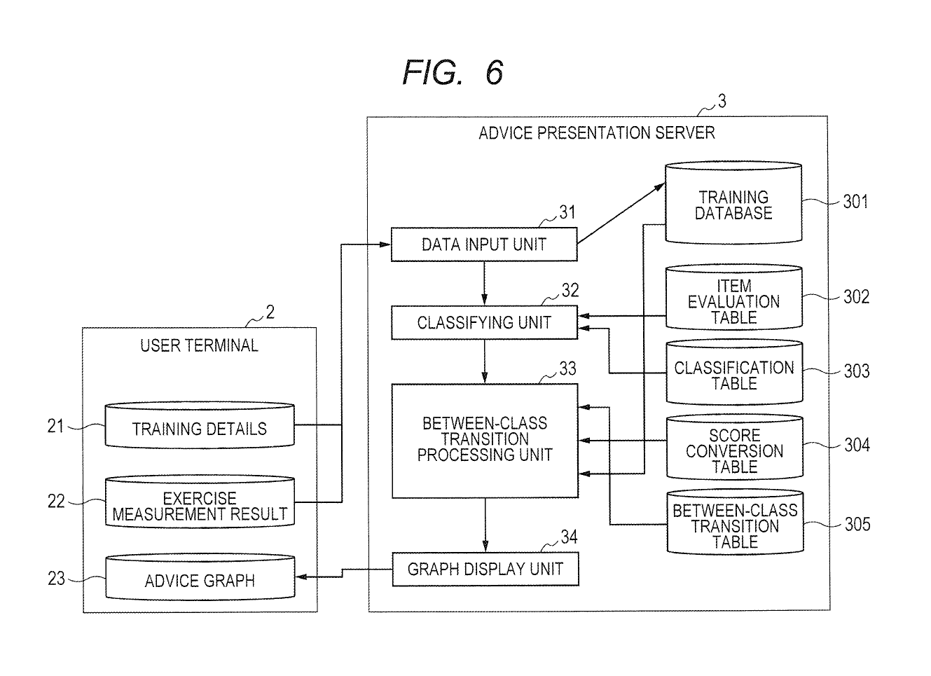

FIG. 6 is a block diagram illustrating a configuration example of a system including an advice presentation server 3 according to Example 1 of the third embodiment. The advice presentation server 3 is an example of the information processing apparatus 1 or 1a. In FIG. 6, a user terminal 2 and the advice presentation server 3 perform communication via a network (not illustrated). The user terminal 2 is an information processing terminal operated by various users using service provided by the advice presentation server 3 and can be realized by a general computer device including an input device and an output device. Consequently, the internal configuration of the user terminal 2 is not illustrated and described in detail. The various users include registrants of training details 21, a user which has achieved a predetermined goal and registers exercise measurement results 22 before and after the achievement, and a user requesting presentation of an advice graph 23 as a piece of advice of a training method from the advice presentation server 3. The training details 21 are an example of the ability improving method 150 and the like and information including a training method, the number of times (frequency), the required period of a training, and difficulty level of the training. The exercise measurement result 22 is an example of the above-described ability state. The advice graph 23 is a directed graph generated on the basis of the between-ability-state relative position information 160 or 160a. Concrete examples of the above will be described later. An “ability class” in the following description is an example of the above-described ability state.

The advice presentation server 3 has a data input unit 31, a classifying unit 32, a between-class transition processing unit 33, a graph display unit 34, a training database 301, an item evaluation table 302, a classification table 303, a score conversion table 304, and a between-class transition table 305. It is assumed that the training database 301, the item evaluation table 302, the classification table 303, the score conversion table 304, and the between-class transition table 305 are stored in the HDD 105. It is also assumed that the data input unit 31, the classifying unit 32, the between-class transition processing unit 33, and the graph display unit 34 are realized when the CPU 101 executes the program 106. Particularly, the between-class transition processing unit 33 is an example of the selecting unit 12 or 12a, and the between-class transition processing unit 33 and the graph display unit 34 are an example of the generating unit 13 or 13a.

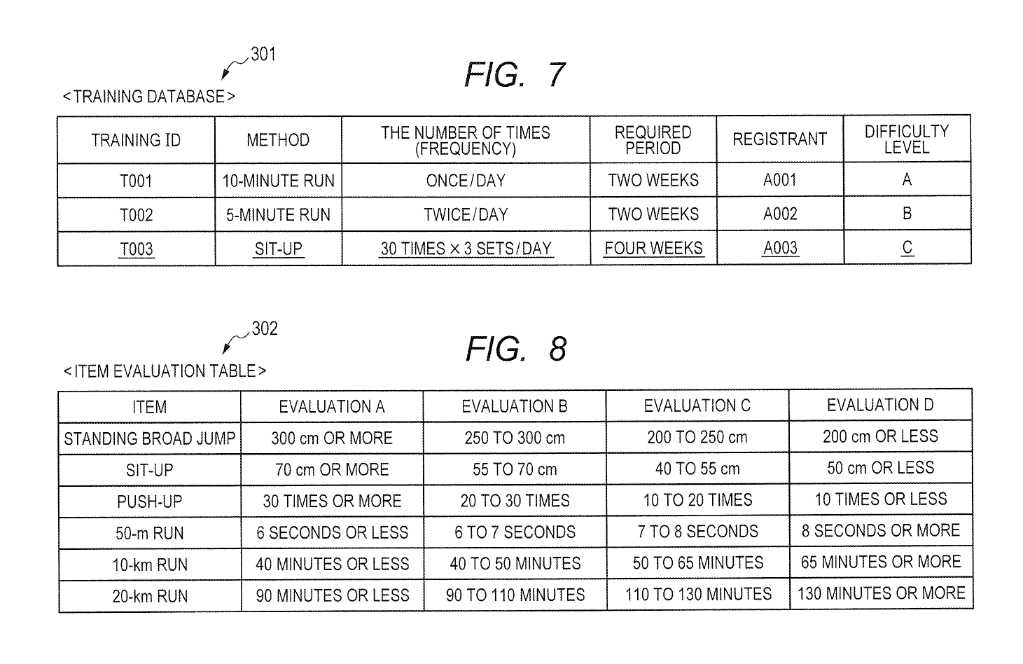

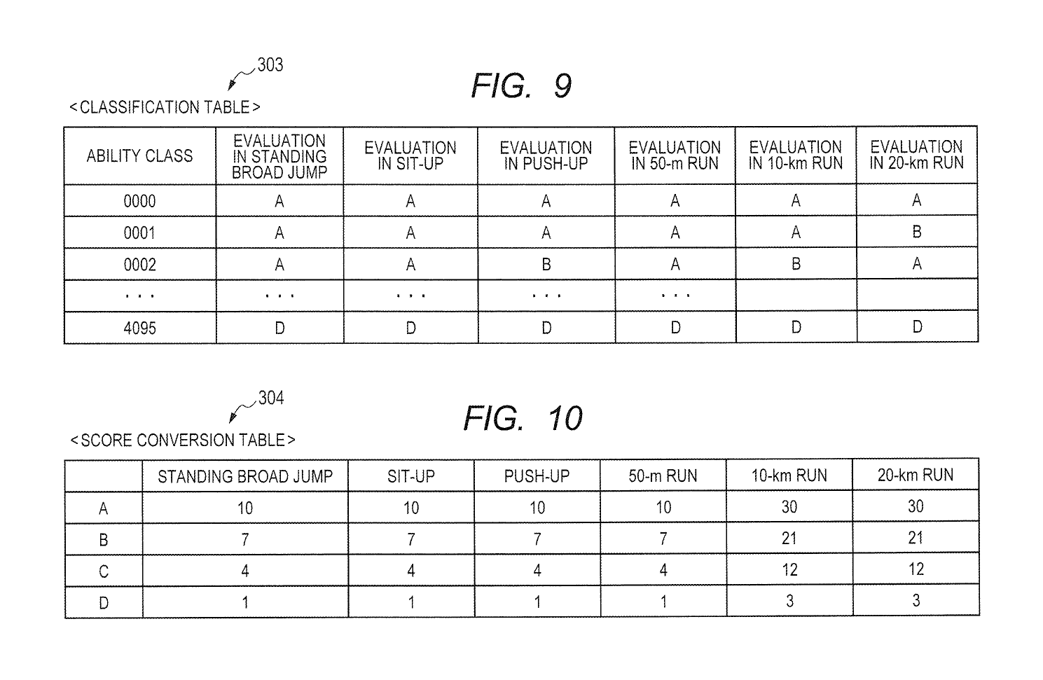

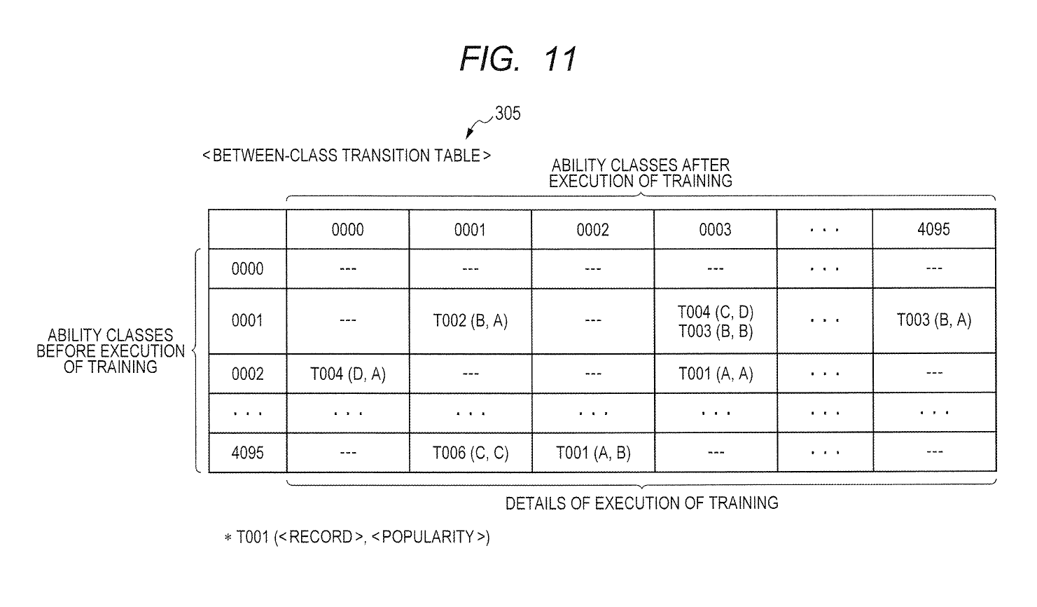

The training database 301 is information for registering and managing the training details 21. Concretely, the training database 301 includes elements such as training ID, training method (content), the number of times (frequency) of training per day, required period, registrant, and difficulty level. FIG. 7 is a diagram illustrating an example of registration data in the training database 301. The item evaluation table 302 is information defining a plurality of measurement items (events) in the exercise measurement results 22 and a range (boundary condition) of evaluation values in the measurement items. FIG. 8 is a diagram illustrating an example of registration data in the item evaluation table 302. The classification table 303 is information defining a set of evaluation values in the items for each ability class. FIG. 9 is a diagram illustrating an example of registration data in the classification table 303. The score conversion table 304 is information defining a conversion rule from an evaluation value to a score for each measurement item. FIG. 10 is a diagram illustrating an example of registration data in the score conversion table 304. The between-class transition table 305 is an example of the state transition information 130 or 130a and is information in which a transition from an ability class before executing a specific training to an ability class after execution of the training and a training ID in the transition are associated. With each of the transitions, a plurality of training IDs can be associated. Together with a training ID, a record (the number of persons executing the training) and popularity (an evaluation value by subjective view of a user who executed the training) of the training can be also included. FIG. 11 is a diagram illustrating an example of the between-class transition table 305.

In the HDD 105, a plurality of pieces of characteristic information corresponding to a plurality of training methods can be stored. The “characteristic information” is information indicating the characteristic of a training method and includes, for example, record, popularity, required period, and difficulty level. “Record” is the number of times (the number of users) the training method is (selected and) executed in a specific transition. “Popularity” is a subjective evaluation value after execution by a user who executed the training method. The record and popularity in the characteristic information in Example 1 are associated with a training ID for each of transitions in the between-class transition table 305. Consequently, even for the same training ID, there is the case that records and popularity associated vary in different transitions. “Required period” is a period required to execute the training method. “Difficulty level” is a subjective evaluation value by a registrant of the training method. The required period and difficulty level in the characteristic information in Example 1 are associated with a training ID in the training database 301. That is, with each of the training IDs, the characteristic information of a plurality of kinds is associated.

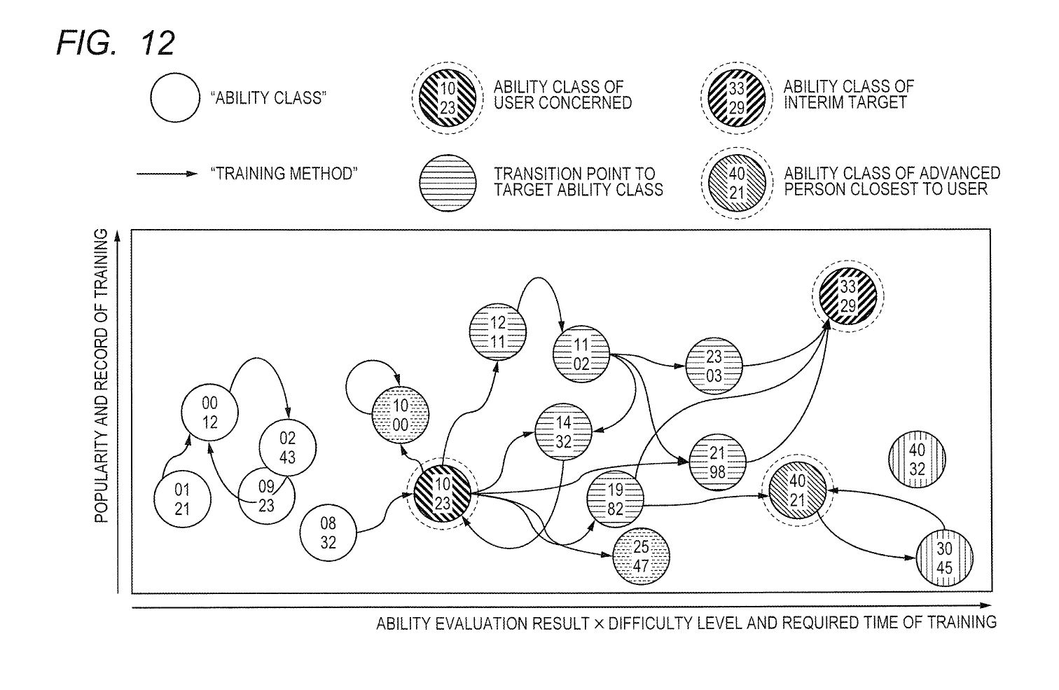

The data input unit 31 receives the training data 21 input from the user terminal 2 and registers it in the training database 301. The data input unit 31 receives the exercise measurement result 22 input from the user terminal 2 and outputs it to the classifying unit 32. The classifying unit 32 refers to the item evaluation table 302 and the classification table 303 and, on the basis of the exercise measurement result 22, classifies a user corresponding to the exercise measurement result 22 into a specific ability class. That is, the classifying unit 32 converts the exercise measurement result 22 to an ability class. The between-class transition processing unit 33 refers to the between-class transition table 305 and specifies a transition from the ability class (first ability state) classified by the classifying unit 32 to an ability class (second ability state) after execution of a training. The between-class transition processing unit 33 refers to the score conversion table 304 and generates between-ability-state relative position information with respect to the ability class classified by the classifying unit 32 and the specified ability class. Particularly, the between-class transition processing unit 33 generates between-ability-state relative position information including relative position relations according to a plurality of pieces of characteristic information corresponding to a plurality of ability improving methods. By the information, the differences in the relative position relations using the first ability state in the second ability state as a reference can be finely expressed. The graph display unit 34 generates display information by an oriented graph on the basis of the between-ability-state relative position information generated by the between-class transition processing unit 33 and outputs and displays the generated information as the advice graph 23 to the user terminal 2. FIG. 12 is a diagram illustrating an example of the advice graph 23. As illustrated in FIG. 12, in the advice graph 23, a plurality of ability classes are mapped onto two-dimensional coordinates, and a before-transition class is coupled to an after-transition class defined in the between-class transition table 305 by an oriented graph. The numerical values in each class denote the number of an ability class. However, the invention is not limited to add numbers in the advice graph 23.

### Example 1-1

### Advice Presentation by Graph Generation

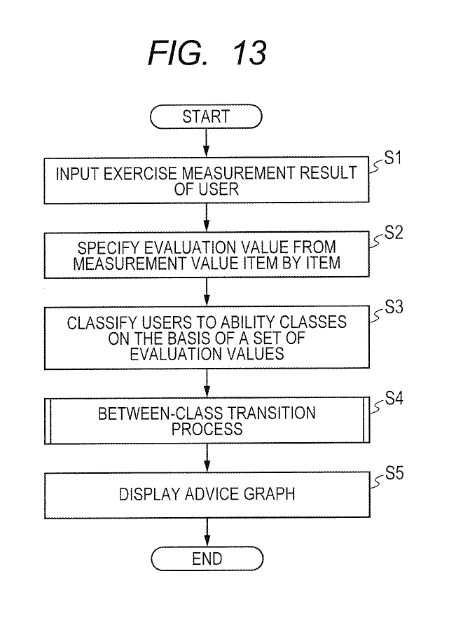

FIG. 13 is a flowchart describing the flow of advice presenting process in Example 1 of the third embodiment. As a precondition, the training database 301, the item evaluation table 302, the classification table 303, the score conversion table 304, and the between-class transition table 305 are already registered.

First, the data input unit 31 receives an input of the exercise measurement result 22 of a user B1 from the user terminal 2 (S1). It is assumed that the user B1 corresponds to a trial user and the data of the exercise measurement result 22 indicates an ability state before achievement of a predetermined goal. The data input unit 31 outputs the received exercise measurement result 22 to the classifying unit 32.

Next, the classifying unit 32 specifies an evaluation value from a measurement value item by item (S2). For example, the classifying unit 32 refers to the item evaluation table 302, determines any of ranges of evaluations A to D to which a measurement value for each of the items in the exercise measurement result 22 corresponds, and specifies the corresponding evaluation value. That is, the classifying unit 32 obtains a set of evaluation values corresponding to the items in the exercise measurement result 22.

Based on the set of evaluation values, the classifying unit 32 classifies the user B1 to an ability class (S3). That is, the classifying unit 32 refers to the classification table 303 and specifies an ability class to which all of the set of evaluation values match.

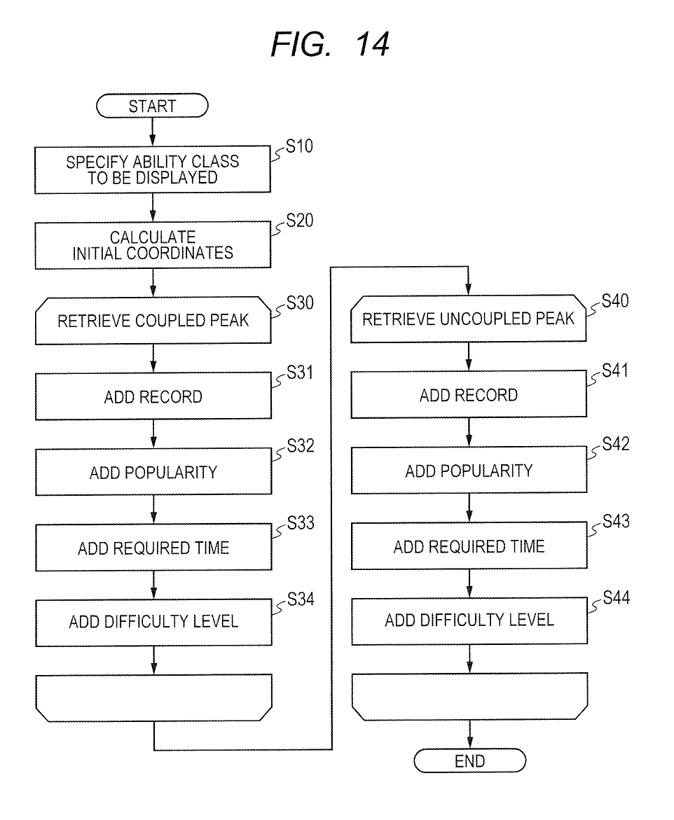

After that, the between-class transition processing unit 33 performs a between-class transition process (S4). FIG. 14 is a flowchart describing the flow of a between-class transition process in Example 1 of the third embodiment. First, the between-class transition processing unit 33 specifies an ability class to be displayed on the advice graph 23 (S10). In this case, the between-class transition processing unit 33 sets all of ability classes set in the between-class transition table 305 as objects to be displayed. An ability class to be displayed may be a group of ability classes after transition changed directly or indirectly from the ability class of the user B1.

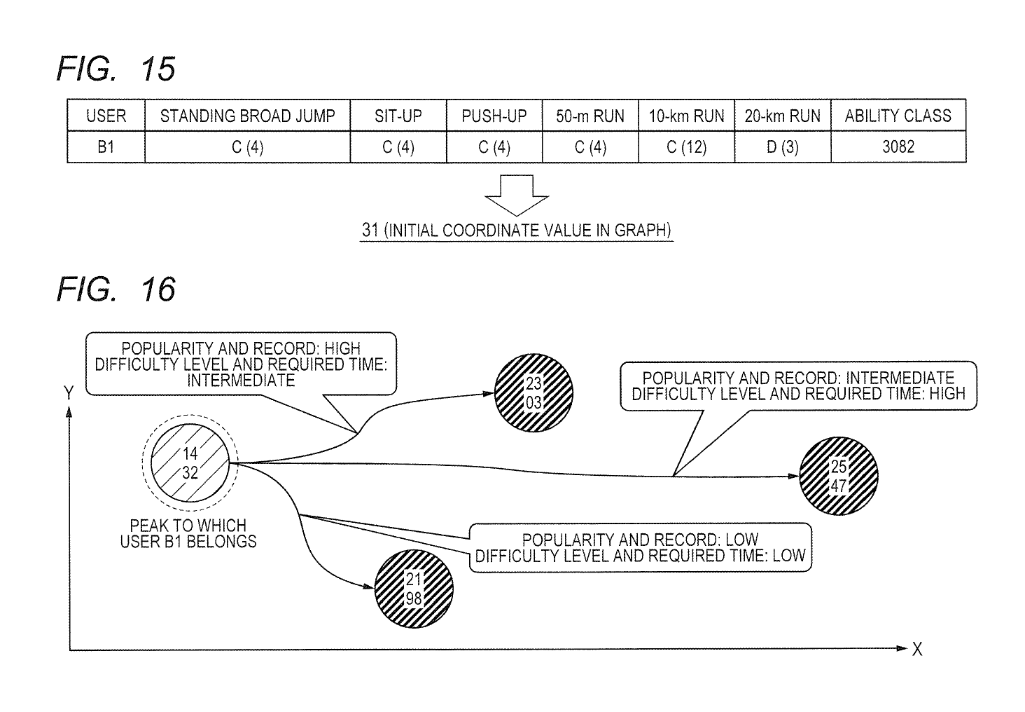

Next, the between-class transition processing unit 33 calculates initial coordinates in the advice graph 23 for each ability class (S20). Concretely, first, the between-class transition processing unit 33 converts an evaluation value for each of the items in the ability classes to an individual score by using the score conversion table 304 for each of the ability classes. The between-class transition processing unit 33 calculates the sum of individual scores as a total score. The total score is used for the initial coordinates of the ability class. For example, the initial coordinates are set so that the calculated total score is on the X coordinate of two-dimensional coordinates and a fixed value is set on the Y coordinate. FIG. 15 is a diagram illustrating an example of scores of the user Bland initial coordinates. At the time of calculating the total score, weighting according to a target may be performed on an individual score of each measurement item. For example, when a target event is a full marathon, it is sufficient to make a weight to an evaluation value of a 20-km run as a long-distance run larger than that to an evaluation value of a 50-m run as a short-distance run. The weighting to a measurement item having low relation to a target event may be set as 0%.

Outline of a method of calculating coordinates of an ability class after transition of a graph in Example 1 of the third embodiment will be described. FIG. 16 is a diagram illustrating an example of the positional relations between a (present) ability state of the user B1 and ability states as a plurality of goals. First, a peak on the graph indicates position coordinates corresponding to each ability class. Using the initial coordinates of the peak of the ability class (1432) of the target user B1 as a reference, the peaks of other ability classes (2303, 2547, and 2198) are changed from the initial coordinates in accordance with a plurality of pieces of characteristic information associated with transitions (that is, training methods). For example, a distance on the X axis is calculated according to the difficulty level and required time, and a distance on the Y axis is calculated according to popularity and record. By the positions to which the peaks are mapped, the user can intuitively grasp a trade-off between the actual degree of effect by a training and severity of the training. Consequently, a training method suited to the polities of a user such as time and motivation can be easily selected.

In the case where a plurality of training IDs are associated with one state transition between ability classes in the between-class transition table 305, at the time of determining coordinates on the graph of the after-transition ability class, the performance and popularity of each of the training methods may be totaled. Alternatively, coordinates may be calculated by using the popularity and performance in a training. Alternatively, coordinates may be calculated by averaging performances and popularities of all of the trainings.

Referring again to FIG. 14, description will be continued. After calculating the initial value of each ability class to be displayed in step S20, a coupled-peak retrieval is performed (S30). The coupled-peak retrieval is a process of retrieving a peak corresponding to another ability class coupled to the peak on the graph corresponding to the ability class of the user B1. It is performed to express a transition between classes by coupling of peaks on a graph and an oriented graph.

In the case where the class determined in step S3 is set to the ability class before execution of a training, the between-class transition processing unit 33 specifies an ability class after execution of a training corresponding to a place in which a training ID is set from the between-class transition table 305. In other words, the between-class transition processing unit 33 specifies an ability class after execution of a training as an after-transition class in the case of setting the ability class of the user B1 corresponding to the exercise measurement result 22 as the ability class before execution of a training. For example, in FIG. 11, when the ability class before execution of a training is ‘0002’, since T004 and T001 are set, ‘0000’ and ‘0003’ as after-transition classes are specified as ability classes after execution of a training.

The between-class transition processing unit 33 executes steps S31 to S34 for each of a plurality of after-transition ability classes using the ability class of the user B1 as a start point. Further, the between-class transition processing unit 33 specifies another ability class as an after-transition ability class from the between-class transition table 305 in the case of setting the after-transition ability class to the before-transition ability class and executes steps S31 to S34 recursively. It is unnecessary to execute the steps again for the ability classes in which the steps S31 to S34 have been executed.

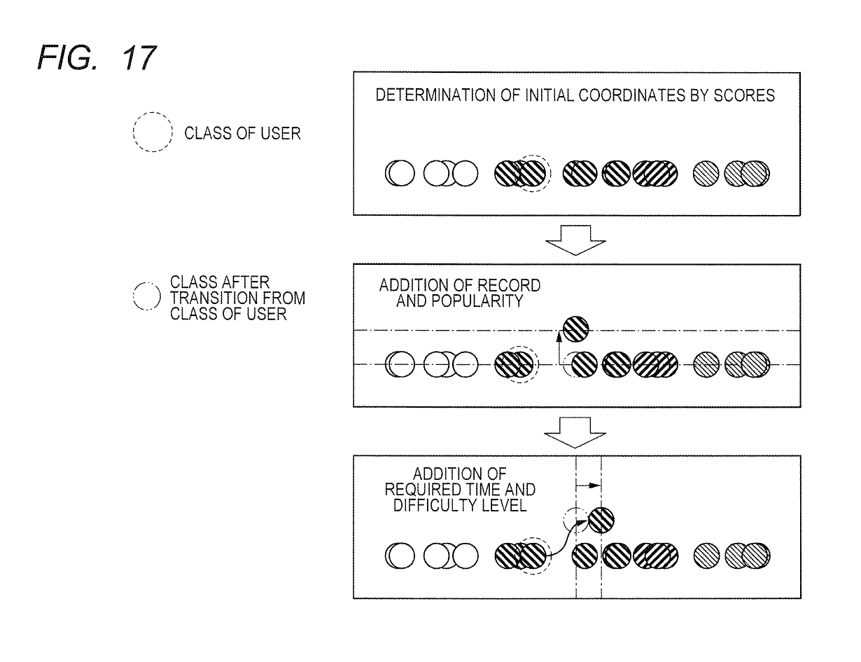

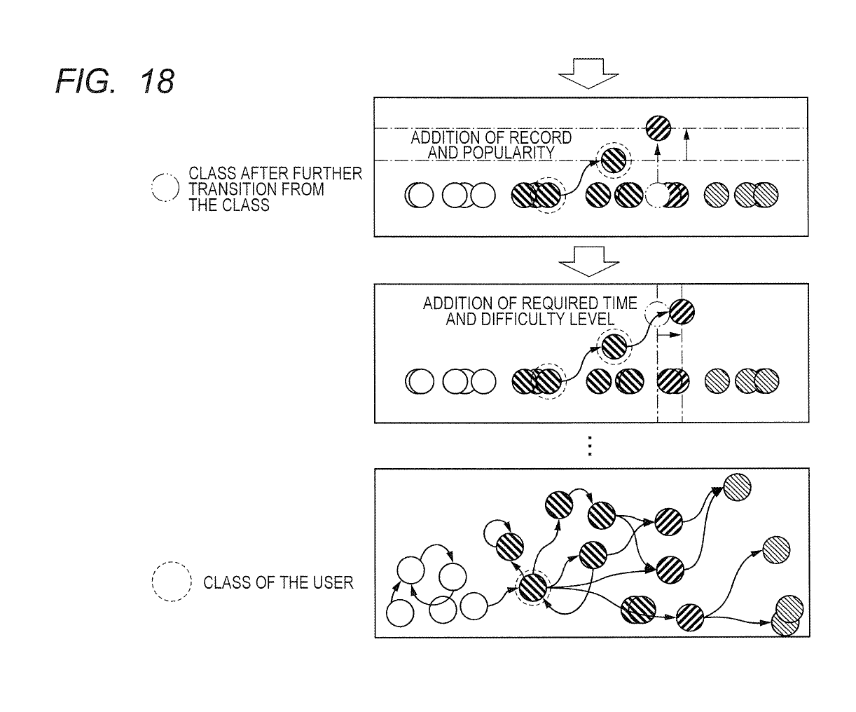

FIGS. 17 and 18 are diagrams for explaining the concept of calculation of coordinates of a class after transition and will be properly referred to in the following description. First, the between-class transition processing unit 33 adds values of performance and popularity associated with the transition to the initial coordinates of an after-transition ability class of the ability class of the user B1 (S31 and S32, and FIG. 17). The between-class transition processing unit 33 adds values of required time and difficulty level associated with the transition to the coordinates after the addition (S33 and S34, and FIG. 17). Subsequently, the between-class transition processing unit 33 specifies, from the between-class transition table 305, an ability-class as an after-transition class in the case where the ability class to which the coordinates are added just before is set as the before-transition class (S30), and executes the steps S31 to S34 to the specified ability class (FIG. 18). After that, transitions are made using the ability class of the user B1 as the start point, and the steps S31 to S34 are repeated recursively to all of ability classes as after-transition classes. When addition of the coordinates to all of the after-transition classes as after-transition classes of the ability class of the user B1 is completed, the process advances to step S40.

Subsequently, the between-class transition processing unit 33 performs uncoupled peak retrieval (S40). The uncoupled-peak retrieval is a process of retrieving an ability class to which a transition is not connected (uncoupled) from the ability class of the user B1 as the start point. The ability classes to which the coordinates are already added in the steps S30 to S34 are excluded. With respect to the relation between a before-transition ability class and an after-transition ability class in all of the ability classes as objects in step S40, like the steps S31 to S34, steps S41 to S44 are executed recursively to the after-transition ability class (FIG. 18). After that, the process advances to step S5.

Referring again to FIG. 13, description will be continued. The graph display unit 34 outputs the advice graph 23 on the basis of the between-ability-state relative position information generated in step S5 and displays it in the user terminal 2 (S5). Specifically, the ability state is expressed by position coordinates in a predetermined coordinate system, and the between-class transition processing unit 33 and the graph display unit 34 generate, as display information, the between-ability-state relative position information as a directed graph in which each transition is expressed by a directed link from the position coordinates corresponding to the first ability state to the position coordinates corresponding to the second ability state according to the characteristic information corresponding to the associated ability improving method and display it to the screen or the like of the user terminal 2. The output destination of the graph display unit 34 is not limited to a screen but may be an arbitrary output device such as a printer.

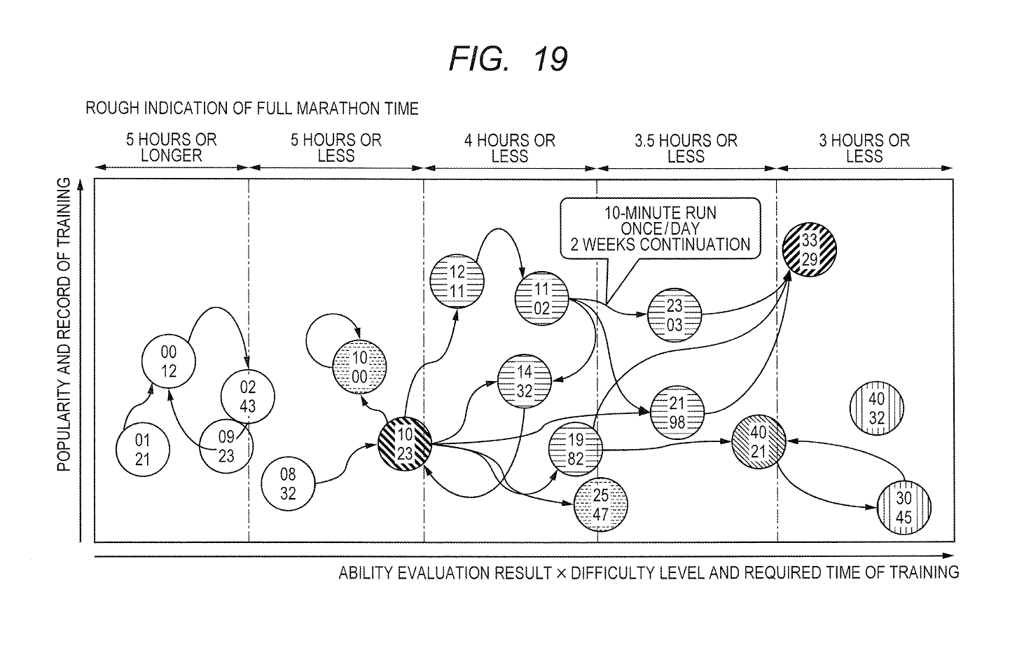

FIG. 19 is a diagram illustrating an example of the advice graph 23. In this example, target completion time of a full-marathon is 3.5 hours or less, transitions from the ability class ‘1023’ of the user B1 to ‘2303’ and the like after goal achievement and trainings are displayed. The trainings may not always displayed in the advice graph 23. For example, when a specific transition is selected by an operation of the user, a training or the like associated with the transition may be displayed. By showing a directed graph, the feasibility for the user can be grasped intuitively. Particularly, when character expression for explaining a training is always displayed, grasp of differences among trainings tends to be complicated. In Example 1, without always displaying trainings in the advice graph 23, the differences of effects by different trainings can be easily grasped by relative position relations of an ability class after goal achievement. Generation of the between-ability-state relative position information based on the characteristic information is not limited to a directed graph. It is sufficient that at least the characteristic information is reflected in the relative position relations of target states using the present state as a reference. For example, another expression such as three-dimensional display may be also employed.

The step S20 and the steps S30 to S34 can be expressed as follows. The between-class transition processing unit 33 calculates a first score by predetermined conversion from a set of the index values in the first ability state, determines position coordinates in a predetermined coordinate system with respect to the first ability state on the basis of the first score, calculates a second score by the predetermined conversion from a set of index values in at least one second ability state selected, determines the position coordinates in the predetermined coordinate system with respect to the selected at least one second ability state on the basis of the second score and the characteristic information corresponding to the transition, and generates the between-ability-state relative position information on the basis of each of the determined position coordinates. In such a manner, the differences of the position relations of the plurality of second ability states after transition can be expressed multilaterally using the first ability state in the user before goal achievement as a reference.

From the above, in Example 1, classification of ability classes according to measurement results is performed in advance for a number of users, and a directed graph configured by using ability classes as “peaks” using the ability class of a user desiring achievement of a goal as a reference and using training methods as “sides” coupling the peaks is visualized and can be presented to the user. By mapping and visualizing peaks by a combination of height of ability and weight of a side (such as popularity, performance, difficulty level, and required time), an optimum training to approach an ideal state and its difficulty level and period are expressed by coordinates on a graph.

By the above, to a user desiring achievement of the goal, paths (transitions) from the present ability state of the user to a plurality of ability states at which the goal can be achieved and a plurality of training methods by which the transitions can be realized can be visually presented from a higher perspective. By expressing difficulty level of realization of each of the ability states by a distance on a graph, selection of a goal adapted to the user and scheduling for realization can be facilitated.

In Example 1, by presenting a plurality of ability classes by which a goal can be realized and visualizing the distance between ability classes, the user can effectively grasp goal setting which is most easily realized and difficult goal setting from the ability class to which the user is classified.

When a plurality of paths exist between the ability class of the user at present and an ability class at which the goal can be achieved (target class), a plurality of orders and combinations of trainings to achieve the goal can be presented, so that the user can make selection.

Since realization difficulty level can be grasped by the distance between the ability class of the user and the target class, by making the user select a goal adapted to the preference of the user from a plurality of target classes existing to achieve the same goal, an effect to maintain motivation can be expected.

Further, a result different from that in the initial schedule is obtained by the training, an ability class to which the user changed in all of the ability classes can be visualized by disposition on a two-dimensional coordinate system. Consequently, without depending on the initial plan, an effective correcting method in the ability class to which the user is classified to a certain time point can be also presented.

A database is configured by records of trainings of a plurality of users and the records are coupled on a graph. Therefore, an advice system in which not only trainings based on one person or knowledge of a group but also knowledge and records of a plurality of trainers are included can be configured.

Further, in a training requiring a long period to achieve a goal, by presenting not only achievement of a training and a subject in front of the user but also a process of growth of the user to achieve a target posture to the user, maintenance of motivation can be assisted.

### Example 1-2

### Trainings and Records Registering Process

Subsequently, as Example 1-2 of the third embodiment, trainings and records registering process will be described. Further, by coupling records of a plurality of users, along-time process of ability improvement is expressed.

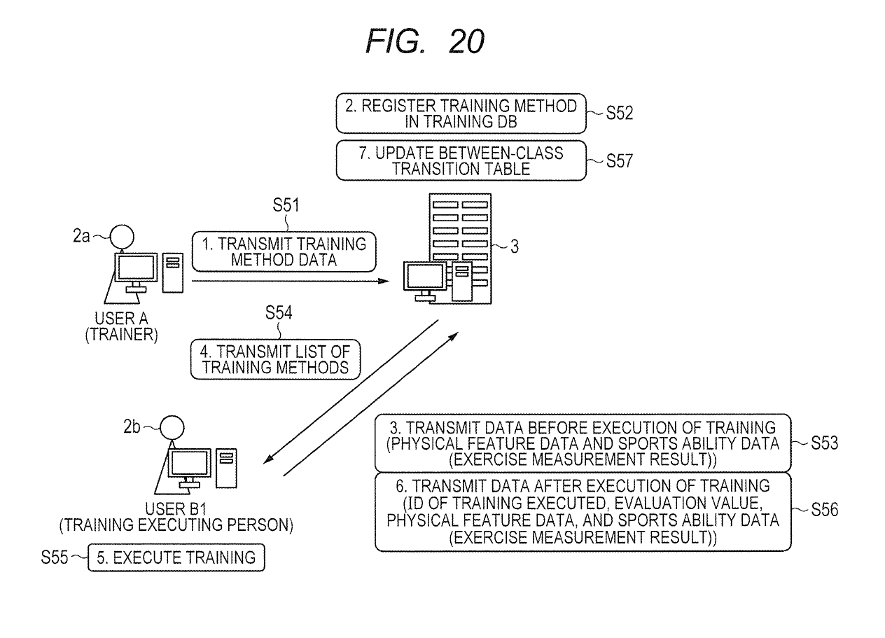

FIG. 20 is a diagram for explaining the concept of process of registering trainings and performances. It is assumed that user terminals 2a and 2b access the address presentation server 3. The user terminal 2a is a terminal operated by a user A corresponding to a trainer of a training. The user terminal 2b is a terminal operated by a user B1 executing a training. It is assumed that there is no functional difference between the user terminals 2a and 2b.

First, the user terminal 2a transmits an input of data of a predetermined training method by operation of the user A to the advice presentation server 3 (S51). The predetermined training method is a training 21 or the like. Next, the advice presentation server 3 registers the received training method into the training database 301 (S52). For example, it is assumed that the training methods illustrated in FIG. 7 are registered.

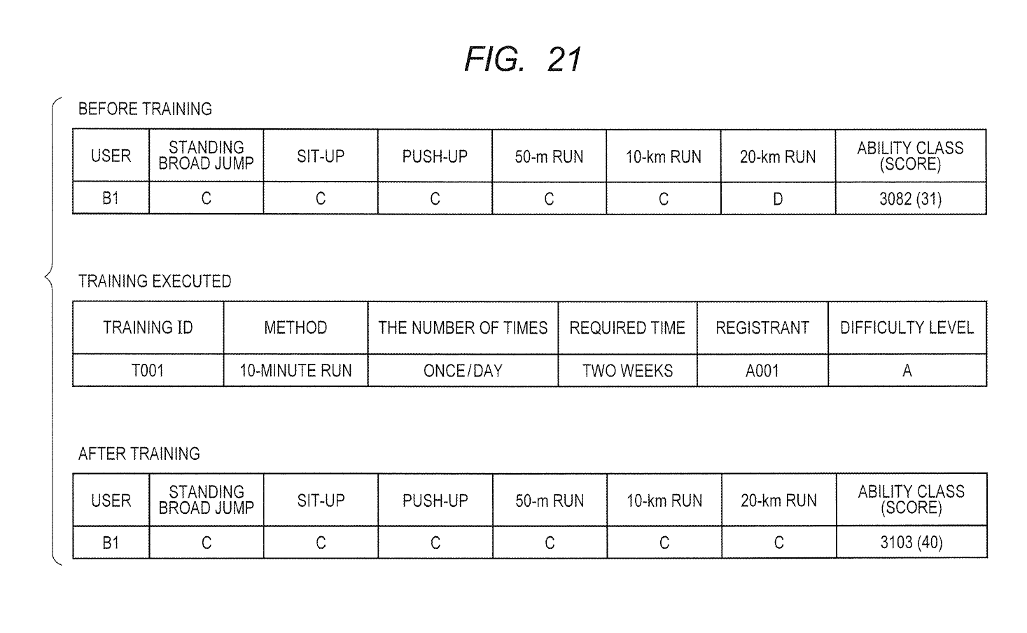

Subsequently, the user B1 measures a predetermined exercise ability and obtains the exercise measurement result 22. The user terminal 2b transmits data before execution of a training to the advice presentation server 3 by an operation of the user B1 (S53). The data transmitted includes physical feature data (for example, body height and weight) and exercise ability data (exercise measurement result 22). Subsequently, the advice presentation server 3 classifies the ability class of the user B1 from the received various data, calculates a score, and holds it (for example, the uppermost table in FIG. 21). The advice presentation server 3 reads a table of training methods from the training database 301 and transmits it to the user terminal 2b (S54). The user terminal 2b displays the list of the training methods received, and it is assumed that the user B1 selects, for example, the training ID “T001” from the list of the training methods displayed (the table in the middle in FIG. 21). The user B executes the training of “T001” (S55).

After that, the user B1 measures the predetermined exercise ability again and obtains the exercise measurement result 22. The user terminal 2b transmits data after execution of the training to the advice presentation server 3 by an operation of the user B (S56). The data transmitted includes, together with the physical feature data of the user B1 and the exercise ability data after execution of the training, the training ID (“T001”) executed and an evaluation value by the user B1 for the training. The advice presentation server 3 classifies the ability class of the user B1 from the received various data and calculates scores (the lowest table in FIG. 21). For example, in the case of FIG. 21, the evaluation value of the 20-km run of the user B1 improves from “D” to “C” after execution of the training ID “T001” and, as a result, the total score improves from “31” to “40”. Accordingly, the advice presentation server 3 sets the ability class before transition to “3082”, sets the ability class after transition to “3103”, and updates the between-class transition table 305 by associating the received training ID “T001” with the popularity and performance obtained by adding 1 as evaluation values received (S57).

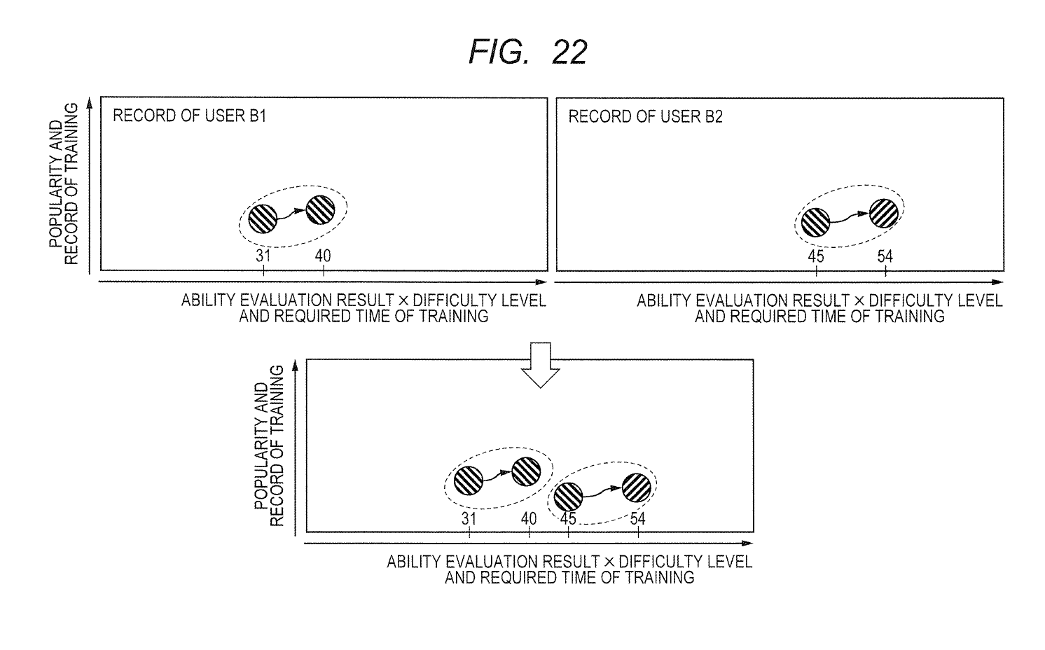

It is assumed that the user B2 in the ability class “45” higher than the score “40” of the ability class after the training of the user B1 exists, and that the score of the ability class after execution of the training by the user B2 improves to “54”. In this case, by executing steps S53 to S57 also for the user B2 (before and after the training), the between-class transition table 305 is updated. FIG. 22 illustrates an example of a result of plotting the result onto the advice graph 23.

Further, when training performances are accumulated, the probability that a plurality of users become the same ability state increases. In another example, it is assumed that the ability class of the user B1 improves from “1023” to “1211” and the ability class of the user B″ improves from “1102” to “2303”. In this case as well, the data is registered in the between-class transition table 305. By plotting it onto the advice graph 23, it is similarly displayed as illustrated in FIG. 22.

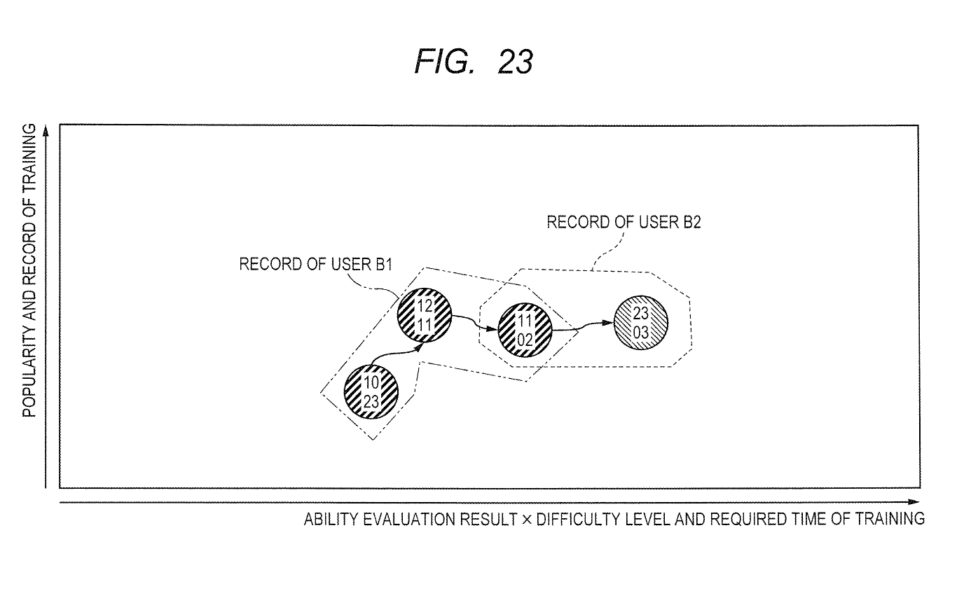

It is assumed that, by executing a part of a plurality of training methods, the ability class of the user B1 improves from “1211” to “1102”. In this case, the ability class after transition of the user B1 and that before transition of the user B2 match at “1102”. FIG. 23 illustrates an example of a result of plotting the situation onto the advice graph 23. In this case, the transitions are coupled and, as a result, the transition from the ability state before transition of the user B1 to the ability state after transition of the user B2 can be expressed.

When there is a user B4 (not illustrated) whose present ability class is “1023”, the user B4 recognizes a combination of a plurality of trainings from “1023” to “2303” and can select it. Consequently, even there is no user who has achieved from a certain ability state to a predetermined goal, by coupling performances of a plurality of users, an achievement process of achieving the goal by the order of training methods can be visualized. Since transitions and training methods in the case of achieving a goal from a certain ability state can be presented in a practical way, selection more suitable to the need of the user can be assisted.

The process performed when training performances are accumulated can be also expressed as follows. The advice presentation server 3 can further include an updating unit. When data is already registered in the training database 301 and the between-class transition table 305 and an input is received from a trial user regarding the ability state of the trial user after executing at least a part of the plurality of ability improving methods, the updating unit updates the state transition information by associating a combination of the transition using the first ability state as the before-transition state and using the ability state of the input as the after-transition state with the ability improving method executed. In this manner, the training performances can be accumulated. Particularly, when training performances are already accumulated, in step S54, like Example 1, a training method more adapted to the need of the user B can be presented. Consequently, the actual ability state of the user B after selecting and executing a proper training method is fed back. Therefore, the precision of advice presented by the advice presentation server 3 improves. For example, popularity and performance in a training ID associated with a transition are updated, so that precision of calculating the coordinates of an ability class from next time improves.

### Example 1-3

### Presentation of Plural Training Methods

Subsequently, as Example 1-3 according to the third embodiment, a case will be described that there are a plurality of ability classes (target classes) at which a goal can be achieved from the present ability class (present-state class) of the user and, particularly, transitions from the present-state class to the target class are made via a plurality of ability classes.

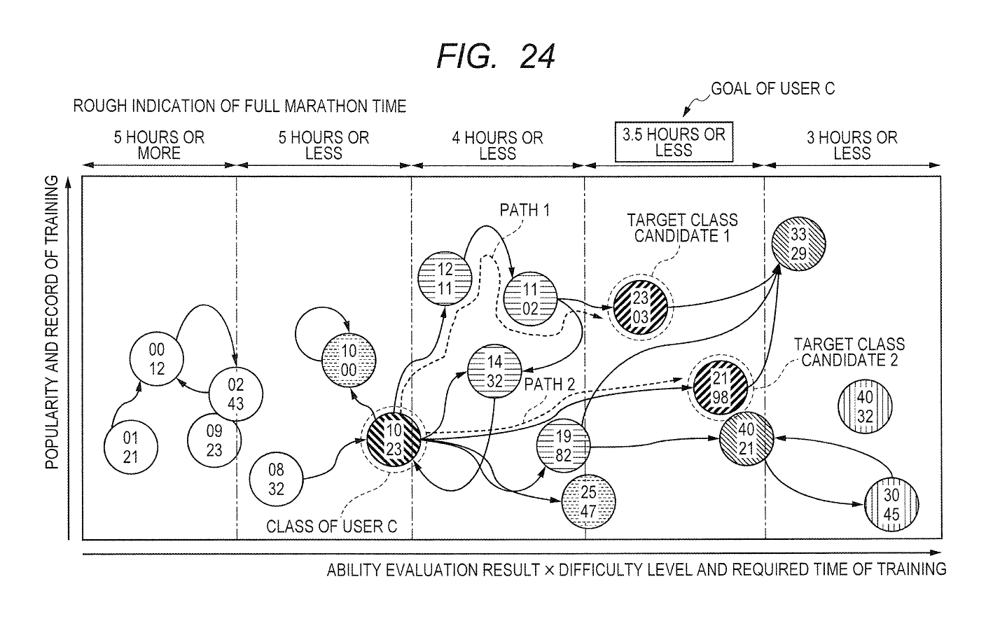

It is assumed that present completion run time of a full marathon of the user C is between four to five hours and a goal of training is between three hours and 3.5 hours. The advice presentation server 3 receives the exercise measurement result 22 of the user C (before execution of trainings) and generates the advice graph 23 on the basis of the present-state class of the user C (FIG. 24). In FIG. 24, the present-state class of the user C is “1023”. Since two ability classes “2303” and “2198” satisfy the target completion run time, they become target class candidates 1 and 2. The target class candidates 1 and 2 indicate classes at which the goal is achieved but are different in training methods and ability classes passed through.

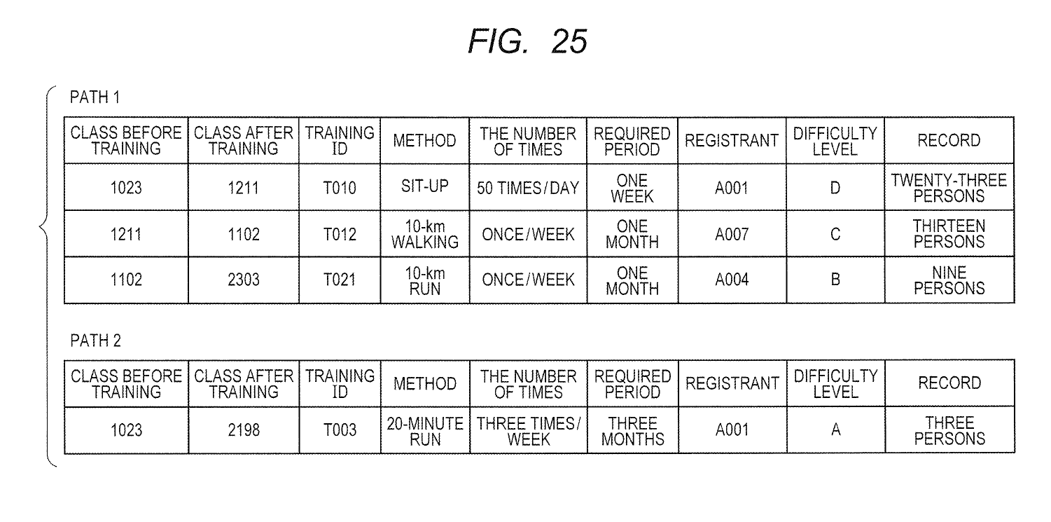

FIG. 25 is a diagram illustrating data of two paths to reach the two target class candidates, respectively. Specifically, from the present-state class “1023” to the target class candidate 1 “2303”, the path 1 is followed. From the present-state class “1023” to the target class candidate 2 “2198”, the path 2 is followed. The path 1 is followed via two ability classes “1211” and “1102” and includes three kinds of training methods. The total of required periods is two months and two weeks, the difficulty level gradually increases from D to B, and the number of persons (record) is larger than that of the path 2. On the other hand, the path 2 reaches the target class candidate 2 directly from the present-state class without passing through other ability classes. Consequently, the path 2 uses only one training method. The required period is three months, the difficulty level is A, and the number of persons is three which is smaller than that of the path 1.

The user C can easily grasp the differences as illustrated in FIG. 25 by comparison between the paths 1 and 2 in FIG. 24. That is, the user C can intuitively grasp the difference between the number of ability classes passed through, the difference in the kinds of training methods, the difference in the difficulty level and required period from the position relation in the X-axis direction, the difference in the record and popularity from the position relation in the Y-axis direction, the trade-off of them, and the like. The user C can select a proper path (training method) in accordance with his/her needs (time which can be spent for training, motivation, and the like).

### Example 1-4

### Example of Aiming at Improvement in Pitching Ability in Baseball

Subsequently, as Example 1-4 of the third embodiment, application of the above-described advice presentation server 3 in the case of setting improvement in pitching ability in baseball as a “goal” will be described. Concrete examples of the goal include “acquisition of a specific pitching form”, “acquisition of a specific breaking ball (acquisition of a fork ball with a drop of N cm)”, “over 130 km/hour of pitch speed”, and “improvement in control” and, in addition, (muscle strength, endurance, control, pitching form, and acquisition of a breaking ball or the like of) famous pitchers. The invention is not limited to the examples.

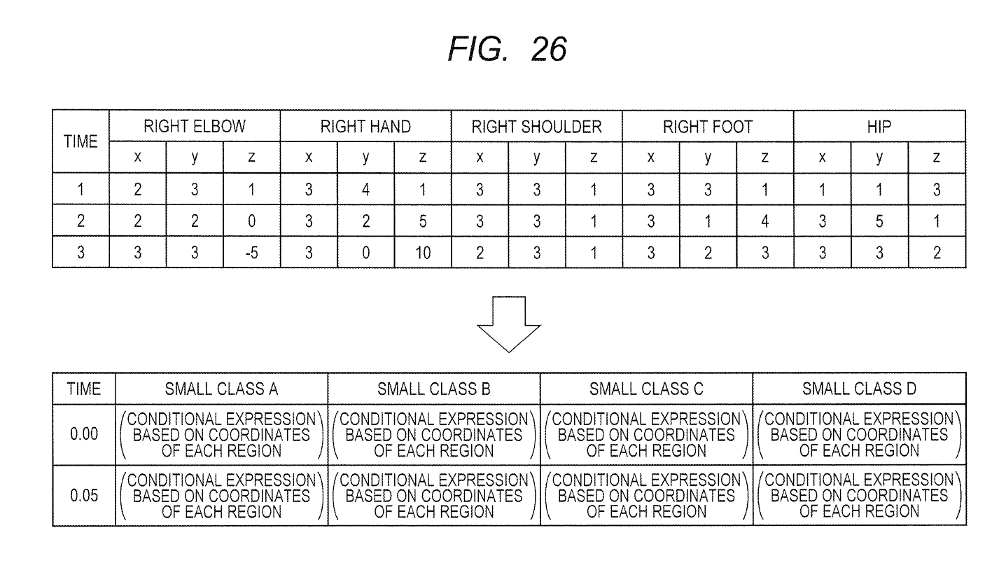

First, as measurement items in the exercise measurement result 22, pitching form, pitch speed, control, locus of a ball, and the like are added. After that, weighting at the time of calculating a total score is adjusted according to a goal. In the pitching form, a time change of coordinates in each of regions of a body is set as a measurement value by using a measuring device such as an acceleration sensor or a motion capture. Sets of x, y, and z coordinates of all of the regions are defined as a plurality of “body postures” (small classes) and the measurement values of coordinates of each of the regions of the body from the start to end of a pitching are converted to postures every predetermined time interval. FIG. 26 is a diagram illustrating an example of relations between measurement values of pitching forms and postures at respective times.

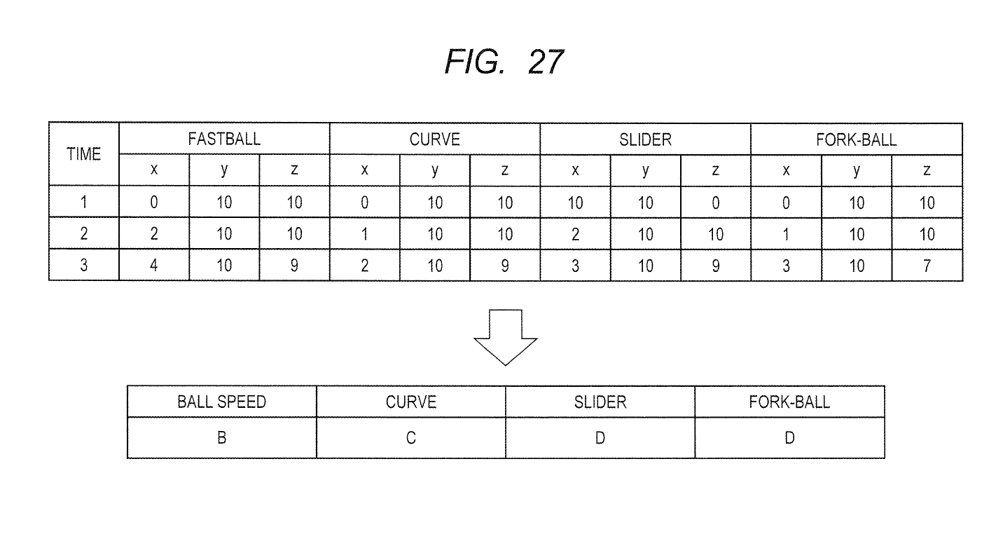

The control can be defined by the ratio of strikes in predetermined number of pitching balls. As the locus of a ball, a time change in the coordinates of a ball by pitch type is used as a measurement value by using a measuring device such as an acceleration sensor or a motion capture. A set of x, y, and z coordinates by predetermined time interval of each pitch type is defined in advance, and a measurement value of the locus of a ball by pitch type is converted to an evaluation value of each pitch type. FIG. 27 is a diagram illustrating an example of changes in time of coordinates of balls and evaluation values by pitch types.

Training methods include basic training (run, muscle training, and the like), shadow pitching, pitching, and the like. By applying the registration data and the setting of the thresholds to the advice presentation server 3 of Example 1, Example 1-4 can be realized.

For example, also in the case of achieving a goal of acquiring the same breaking ball, a plurality of training methods exist and the details, required period, performance, popularity, difficulty level, and the like are various. Consequently, from the advice graph 23, a user can visually recognize trainings executed by persons whose abilities were similar to the ability of the user and who realized the goal. Therefore, the user grasps all of various trade-offs including severity of trainings and requires time and can select a training method adapted to the need of the user himself/herself.

### Example 1-5 Example of Acquisition of Knowledge and Skill

Subsequently, as Example 1-5 of the third embodiment, application of the advice presentation server 3 to the case where acquisition of knowledge and skill is a “goal” will be described. Concrete examples of a goal are “passing (score) of a qualifying examination”, “total score of all of subjects of examination at school”, “participation in training course”, and the like but the present invention is not limited to those examples. When a goal is “passing (score) of a qualifying examination”, for example, scores of examination subjects are set as measurement values in the exercise measurement result 22, and a separation line is set as a passing score of each subject. In the case of “total score of all of subjects of examination at school”, similarly, scores of English, mathematics, national language, science, social studies, and the like are set as measurement values, and evaluation values are classified in the ranges of the scores. Further, as measurement items of ability states, basic memorization ability, calculation speed, and the like can be included.

Examples of the learning methods (ability improving methods) include memorization, oral reading, iterative calculation, and application learning. By applying settings of registration data and thresholds to the advice presentation server 3 of Example 1, Example 1-5 can be realized.

For example, also in the case of realizing the same score in an examination, a plurality of learning methods exist and preference is different among users. Consequently, by using the advice graph 23, to realize a target score, the user can grasp various trade-offs such as hardness and required time of the learning methods and select a leaning method suitable to his/her needs.

### Fourth Embodiment

### Switching of Recommended Ability Improving Method According to User's Designation

Subsequently, as a fourth embodiment, the case of changing a recommended training method according to designation of a user will be described. Description of parts similar to those in the third embodiment will be properly omitted. For example, the configuration of the advice presentation server 3 in the fourth embodiment is similar to that in the third embodiment described with reference to FIG. 6, the description will not be repeated.

In the fourth embodiment, the characteristic information includes a plurality of kinds of sub-characteristics (required period, difficulty level, and the like), and the generating unit generates the between-ability-state relative position information in accordance with designation of priority of the sub-characteristic from the trial user. Specifically, when designation of priority of characteristic information is received from the user, the weight on high-priority characteristic information is increased, the weight on low-priority characteristic information is decreased, and position coordinates of ability classes in a graph are calculated. On the basis of the calculated position coordinates, the ability classes are disposed in the graph. By the operation, a training method closer to the preference of the user and target class candidates can be disposed closer to the present-state class of the user. Consequently, the user can select a training in which the preference of the user himself/herself is reflected more easily.

### Example 2-1

### Priority on Period

Example 2-1 in the fourth embodiment relates to the case where the user C designates priority on the required period in the characteristic information. In this case, at the time of calculating an X coordinate in an ability class after transition, the advice presentation server 3 makes weight on the required time larger than that on the difficulty level. Consequently, among a plurality of target class candidates, the adjustment amount of the X coordinate according to the difference in the required period becomes more conspicuous as compared with the difference in the difficulty level. That is, as the required period becomes longer, the distance in the X direction from the present-state class of the user C increases. As a result, even if the difficulty level is relatively high, the ability class with shorter required period is disposed closer to the present-state class.

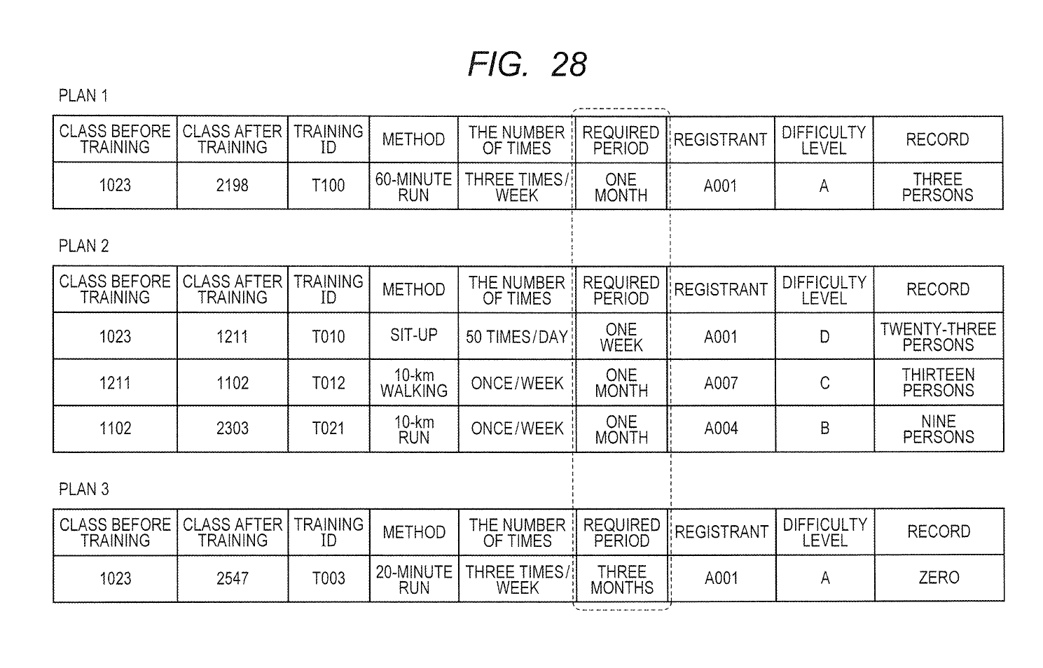

FIG. 28 is a diagram illustrating an example of presentation orders of training plans when priority is placed on required time. For example, at the time of generating a directed graph to satisfy a predetermined goal (3.5 hours or less of completion run time of a full marathon) in accordance with measurement results of the user C, the advice presentation server 3 receives a designation to place priority on the required period from the user C. Since the required period of plan 1 is one month, that of plan 2 is two months and one week in total, and that in plan 3 is three months, training plans are presented in the order of plans 1, 2, and 3 as illustrated in FIG. 28.

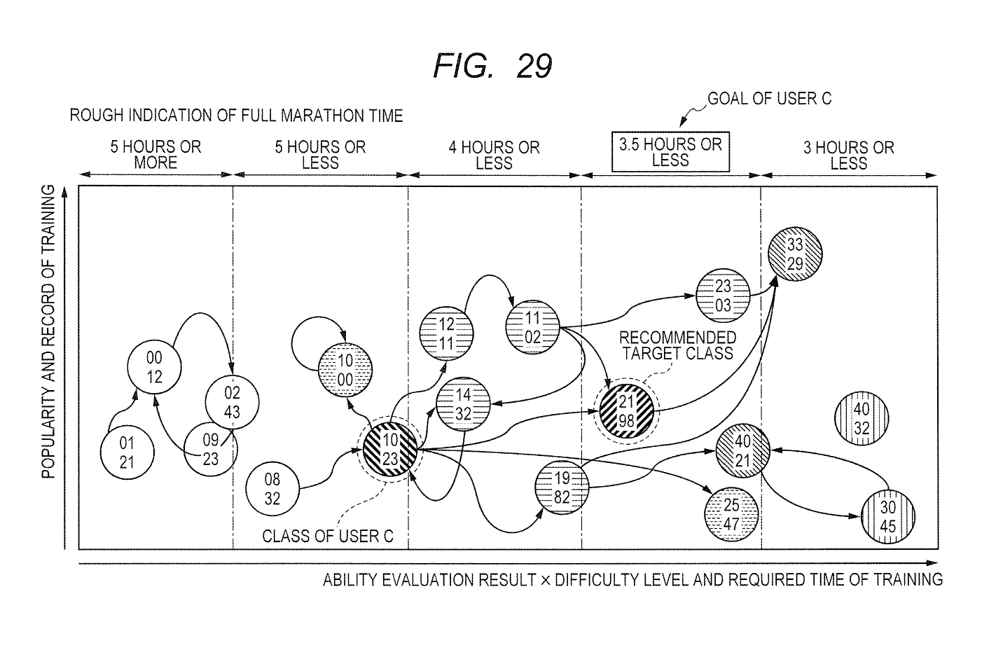

FIG. 29 is a diagram illustrating a display example of the advice graph 23 when priority is placed on required time. In this case, particularly, the recommended target class “2198” of the highest-priority plan 1 is disposed closest to the present-state class of the user C in the X-axis direction.

### Example 2-2

### Priority on Difficulty Level

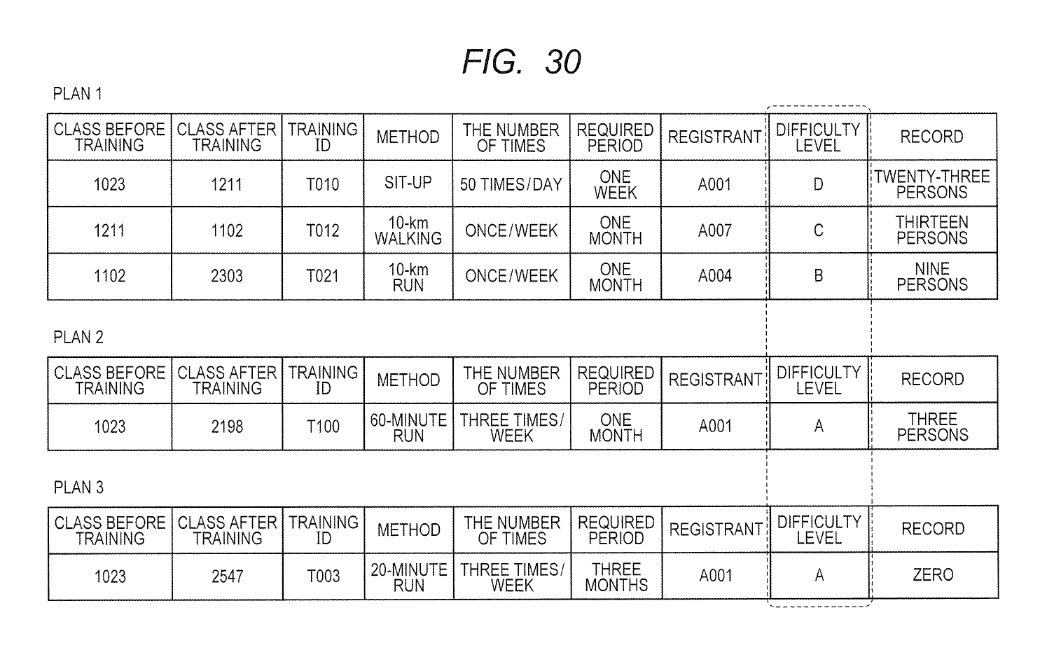

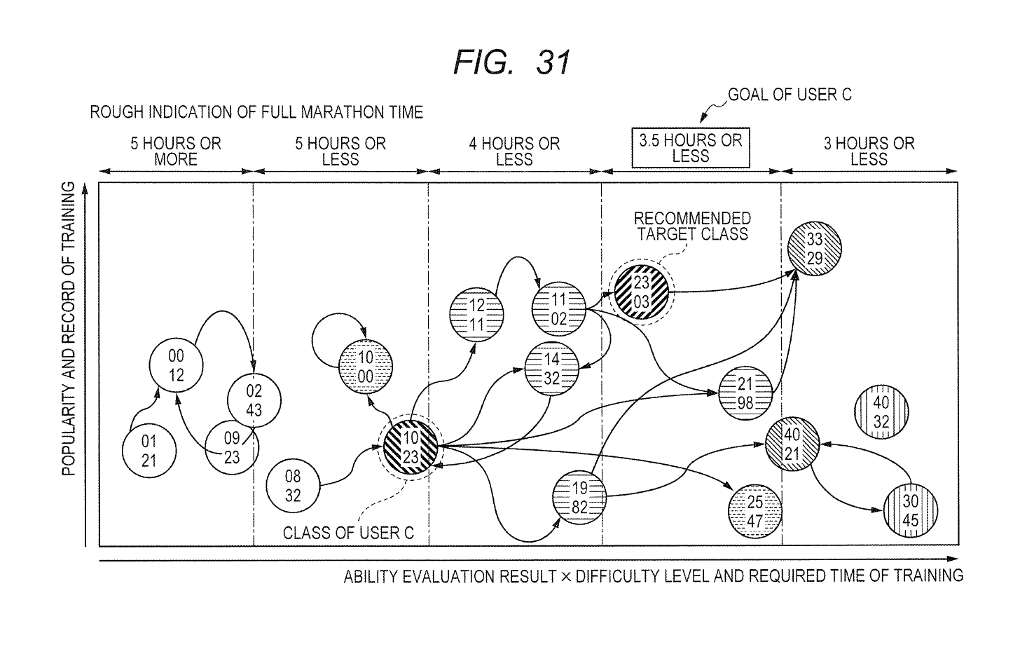

Example 2-2 in the fourth embodiment relates to the case where the user C places priority on the difficulty level in the characteristic information. In this case, the handling of the required period in Example 2-1 is replaced with that of the difficulty level. Therefore, as illustrated in FIG. 30, the highest priority is placed on plan 1 in which the average of difficulty levels is lowest. FIG. 31 illustrates that the recommended target class “2303” of the highest-priority plan 1 is disposed closest to the present-state class of the user C in the X-axis direction.

### Fifth Embodiment

### Neighborhood Class Coupling Method

As a fifth embodiment, a method (neighborhood class coupling method) of presenting, as a training candidate, a training method having a record in the case of setting, as a ability class before transition, an ability class in the neighborhood of (or close to) the ability class to which the user is classified will be described. Description of parts similar to those in the third embodiment will not be repeated. For example, since the configuration of the address presentation server 3 is similar to that in the third embodiment described with reference to FIG. 6, it will not be described in the fourth embodiment.

In the fifth embodiment, the ability state is expressed by position coordinates in a predetermined coordinate system. The selecting unit specifies an ability state within a predetermined range from the position coordinates corresponding to the ability state of the trial user and, further selects the second ability state as an after-transition ability state in the case where the specified ability state is set as the first ability state on the basis of the state transition information. The generating unit generates the between-ability-state relative position information by including the specified second ability state.

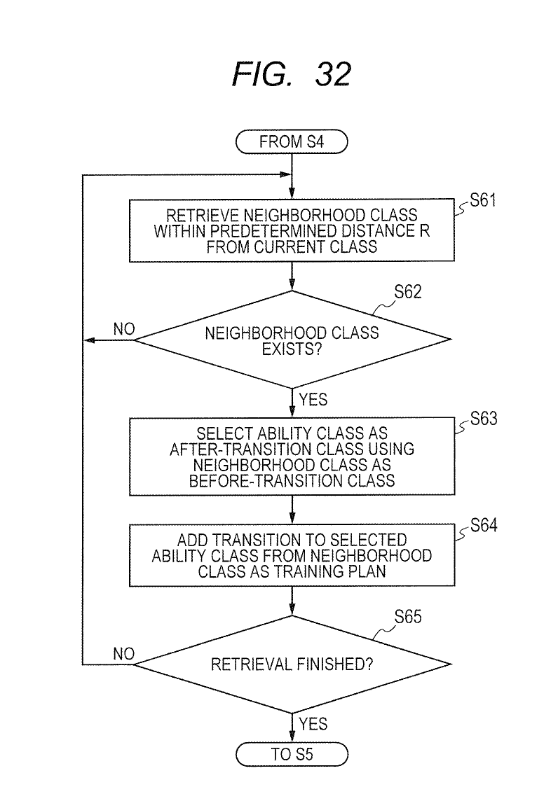

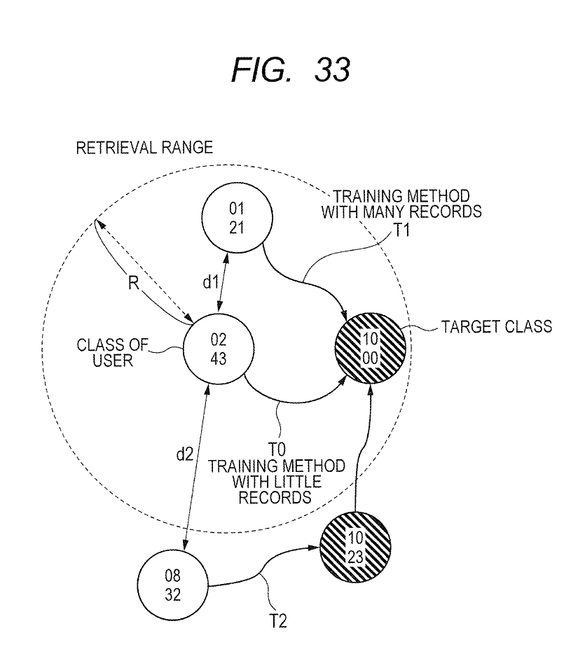

FIG. 32 is a flowchart illustrating the flow of neighborhood class retrieving process according to the fifth embodiment. FIG. 33 is a diagram for explaining the concept of a neighborhood class coupling method. As a precondition, it is assumed that the process was executed until step S4 in FIG. 13. Consequently, the position coordinates of each of the ability classes are already calculated. At this time, the between-class transition processing unit 33 retrieves an ability class (neighborhood class) within a predetermined distance from the present-state class (S61). For example, it is assumed that the transition from “0243” to “1000” in FIG. 33, that is, the number of records in the training method T0 is less than predetermined number. In this case, the between-class transition processing unit 33 retrieves an ability class within predetermined distance R from “0243”. In this example, since distance d1 between “0243” and “0121” is shorter than the distance R, “0121” is retrieved as a neighborhood class (YES in S62). On the other hand, since distance d2 between “0243” and “0832” is longer than the distance R, the class is not retrieved as the neighborhood class (NO in S62). Concretely, for example, the between-class transition processing unit 33 determines that the distance between the position coordinates of “0243” and the position coordinates of “0121” is within the predetermined range R (YES in S62). The between-class transition processing unit 33 refers to the between-class transition table 305 and specifies the ability class “1000” as an after-transition class whose training record is equal to or larger than the predetermined number when “0121” specified as a neighborhood class is set as the before-transition class (S63). After that, between-class transition processing unit 33 adds the transition from the neighborhood class “0121” to “1000” as a training plan to update the between-ability-state relative position information (S64).

After that, when an ability class to be retrieved remains, without finishing the retrieval (NO in S65), the process returns to step S62. On the other hand, when there is no ability class to be retrieved, the retrieval is finished (YES in S65) and the process advances to step S5 in FIG. 13.

As described above, in the fifth embodiment, for example, when the record that the training method was executed by other users in the past in the present-state class of the user is small, a class in the neighborhood from the present-state class is retrieved, a training in the retrieved class and a training in the case of changing from the retrieved class to the target class are compared, and the training having the larger number of records is recommended. Consequently, a training can be efficiently selected.

Particularly, for a while after operation of the advice presentation server 3, it is assumed that no record of the training is registered for the ability class to which the user is classified. Even in such a case, not “no recommended training” but an alternate training by which an effect is expected can be proposed.

Alternatively, when training record registered in the class to which the user is classified is not effective, a replacing training by which an effect is expected may be proposed.

### Sixth Embodiment

### Classification According to Physical Characteristics

In the third embodiment, all of ability classes are defined in the between-class transition table 305. Particularly, in Example 1 and the like, all of ability classes are defined in the same graph. However, even when the same training method is executed, if physical characteristics are different, the possibility that the difference between ability classes after execution is large is high. In such a case, it is not beneficial to display all of the ability classes in the same graph.

As a sixth embodiment, a technique of dividing the between-class transition table 305 by physical characteristics of the user, generating state relation information for an ability class in a corresponding physical characteristic and, as a result, displaying only ability classes having common physical characteristics in graph display will be described. Description of parts similar to those of the third embodiments will not be repeated. For example, since the configuration of the advice presentation server 3 in the sixth embodiment is similar to that of the third embodiment described with reference to FIG. 6, its description will not be repeated.

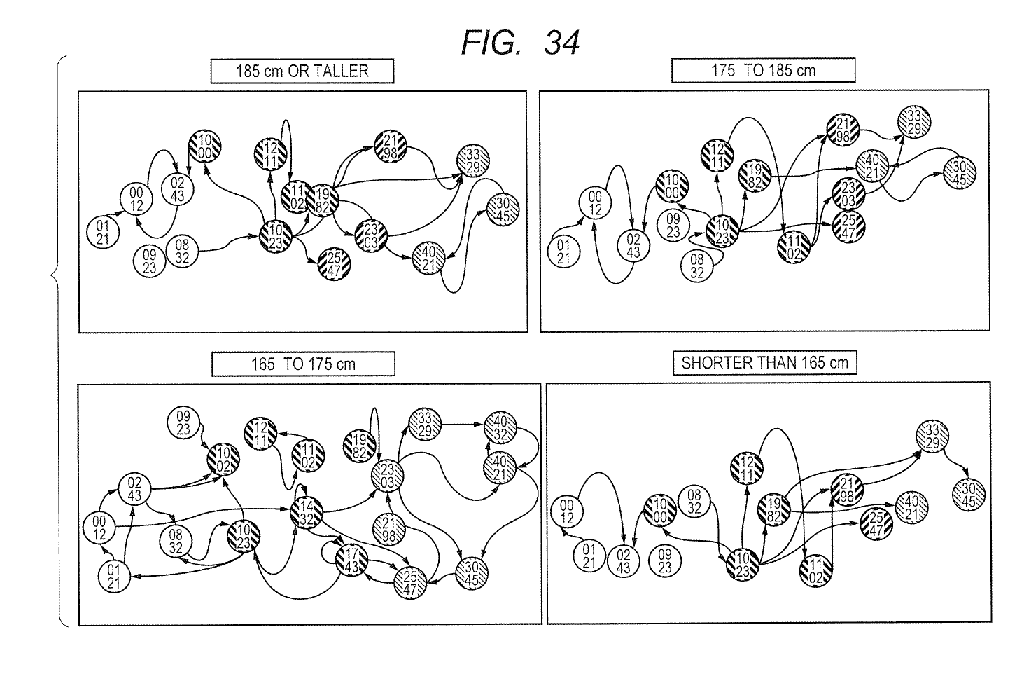

In the sixth embodiment, the storing unit stores a plurality of pieces of the state transition information according to attributes related to the body of a user, and the selecting unit selects, when an input of the attribute of the trial user is received, the state transition information according to the attribute and selects at least one second ability state on the basis of the selected state transition information. The “attributes related to the body of a user” corresponds to the above-described physical characteristics and include, for example, height, weight, length of an arm, length of a leg, sex, and age. Concretely, ranges of physical characteristics can be defined that, for example, the height is in a range less than 165 cm, in a range from 165 cm and less than 175 cm, in a range from 175 cm and less than 185, and in a range from 185 cm. In this case, the HDD 105 stores the between-class transition table 305 for each of the ranges of the physical characteristics. When an input of the height is received from a user, the advice presentation server 3 specifies the corresponding range of the physical characteristic from the above-described four ranges, and generates and displays the advice graph 23 by using the between-class transition table 305 corresponding to the specified range. FIG. 34 is a diagram illustrating an example of the advice graph 23 for each of the four ranges by the physical characteristic.

According to the sixth embodiment, a training plan of high effect based on performance data of a user having a similar physical characteristic can be presented to a user. The generating unit according to the sixth embodiment may generate a plurality of pieces of between-ability-state relative position information according to the plurality of physical characteristics in advance, present a plurality of graphs and physical characteristics according to the graphs as physical characteristic candidates to the user, and make the user select a graph similar to his/her physical characteristic from the plurality of graphs.

### Seventh Embodiment

### Integration of Ability States

In Example 1 in the third embodiment, six measurement items of physical abilities are evaluated in four stages and classification to 4,096 ability classes is made. When the number of records of trainings by users is small, even if the classification table 303 is used in which ability classes are finely classified, the probability that a user adding the training records is classified to the ability class to which the user was already registered is low, and the possibility that graphs are coupled is low.

In the seventh Embodiment, the desired ability state corresponds to any of the plurality of ability states aimed by the trial user to achieve a predetermined goal, and the storing unit further stores a plurality of index values corresponding to abilities of the plurality of registered users and in indices related to the goal and a predetermined classification definition for classifying users from the plurality of index values to the plurality of ability states. There is also provided an integrating unit which integrates a part of the plurality of ability states by changing the predetermined classification definition in accordance with a designation from the outside or a result of analysis of the plurality of index values at a predetermined timing. The selecting unit applies the changed classification definition to each of the plurality of index values to classify the plurality of registered users to any of the plurality of integrated ability states, and performs the selection using the plurality of ability states to which the plurality of registered users are classified as the second ability state. By integrating and visualizing the ability classes as described above, the configuration of the advice graph is made simple and viewability can be improved. An “index related to a goal” may be a plurality of indices. In this case, the “index value” is a set of index values. Consequently, the set of index values includes the exercise measurement result 22. Examples of the “classification definition” include the item evaluation table, the classification table 303, and the score conversion table 304. However, the invention is not limited to the tables. Further, the “predetermined opportunity” is, for example, a timing when an instruction of change start of the classification definition is received from the user or a timing of periodically starting analysis of the amount of registration data in the exercise measurement result 22, but it is not limited. The “designation from the outside” is, for example, designation of a change of a range of indication values from the user who instructed the change start of the classification definition. The “analysis result of a plurality of index values” is, for example, an analysis result that the registration data amount of the exercise measurement result is below a threshold. Description of parts similar to those of the third embodiment will not be repeated. For example, the configuration of the advice presentation server in the fourth embodiment is similar to that in the third embodiment descried with reference to FIG. 6, the description will not be repeated.

### Example 5-1

Example 5-1 in the seventh embodiment relates to the case of determining elimination and integration of ranges of evaluation values in the item evaluation table 302 from history of the exercise measurement result 22 from the user and updating the item evaluation table 302 so as to perform elimination and integration. An example of means for realizing the above is as follows. First, the advice presentation server 3 stores history of the exercise measurement result 22 registered by the user into the HDD 105 or the like. The advice presentation server 3 analyzes history of the exercise measurement result 22 at a predetermined opportunity and calculates the number of classifications of each of evaluation values A, B, C, and D by measurement item. As a result, when it is determined that the number of classifications of the valuation values B and C in a certain measurement item is considerably smaller (for example, zero) as compared with that of the evaluation values A and D, the advice presentation server 3 updates the item evaluation table 302 by consolidating the ranges of the evaluation values B and C in the measurement item in the item evaluation table 302 to newly set one evaluation value B and replacing the evaluation D with C. That is, the advice presentation server 3 changes the ranges of the evaluation values in the item evaluation table 302. In addition, the advice presentation server 3 eliminates a group of sets of evaluation values which become unnecessary in the classification table 303 and updates correspondence with the ability classes. That is, by updating the classification table 303, the advice presentation server 3 consolidates parts of the ability classes. After that, the advice presentation server 3 applies an updated item evaluation table 302a and an updated classification table 303a to the exercise measurement results 22 of the users, classifies the users to the updated ability classes and generates a graph by using the ability classes after the classification.

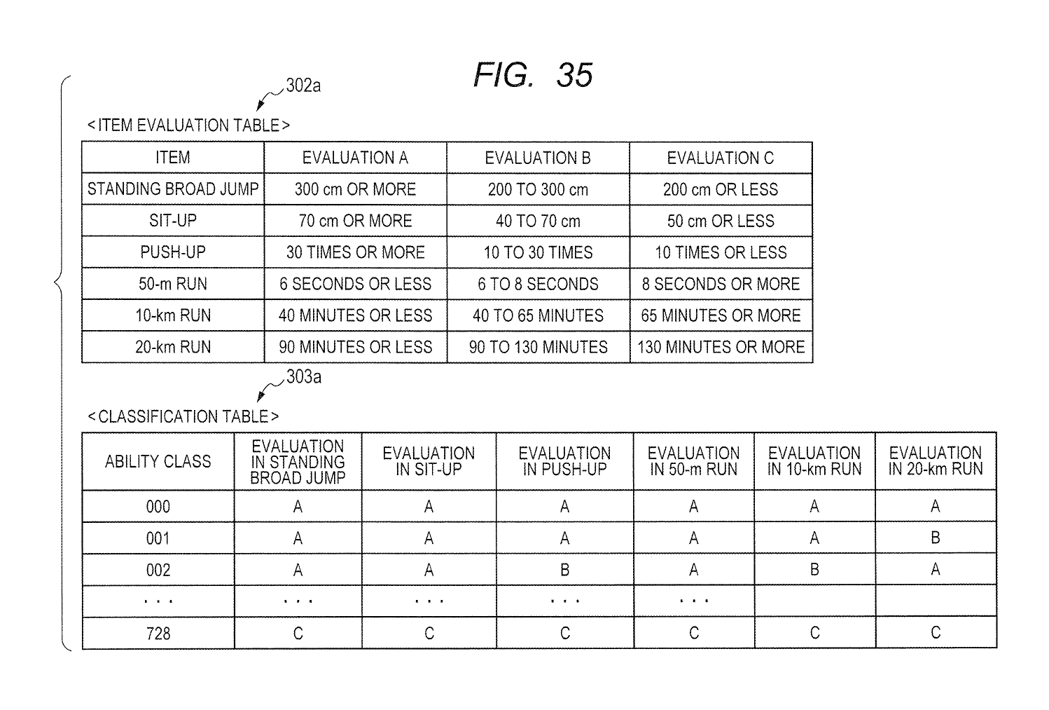

FIG. 35 is a diagram illustrating an example of the item evaluation table 302a and the classification table 303a after integration of Example 5-1 according to the seventh embodiment. The item evaluation table 302a is a result of reducing four-grade evaluation on six measurement items in the item evaluation table 302 to three-grade evaluation. Accordingly, the classification table 303a is a result of reducing the number of ability classes registered in the classification table 303 from 4096 to 729.

### Example 5-2

Example 5-2 in the seventh embodiment relates to the case of eliminating an item having low relation to a goal in a plurality of measurement items from the item evaluation table 302. An example of means for realizing the above is as follows. When an instruction of eliminating a part of measurement items is received from a user, the advice presentation server 3 eliminates the record of the instructed measurement item from the item evaluation table 302 to update the item evaluation table 302. With the updating, the advice presentation server 3 updates the classification table 303 by eliminating the attribute of the corresponding measurement item in the classification table 303 and consolidating ability classes in which sets of evaluation values overlap to generate a new ability class. That is, the advice presentation server 3 consolidates the ability classes by changing the kind of a measurement item (classification definition) in the item evaluation table 302 and the classification table 303.

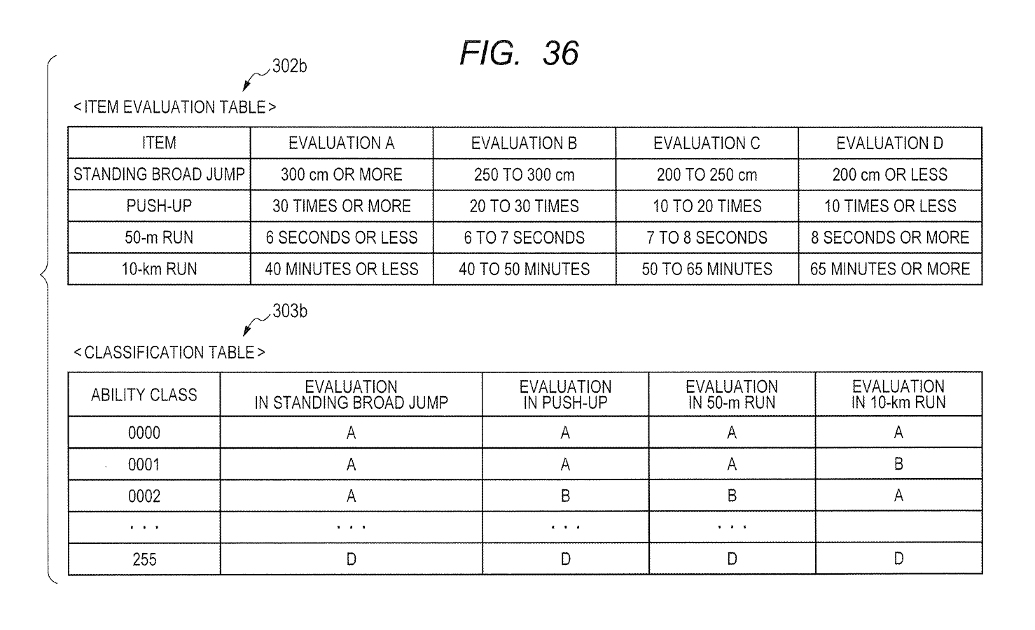

FIG. 36 is a diagram illustrating an example of an item evaluation table 302b and a classification table 303b after integration of Example 5-2 according to the seventh embodiment. The item evaluation table 302b is a result of reducing six measurement items in the item evaluation table 302 to four. Accordingly, the classification table 303b is a result of reducing the number of ability classes registered in the classification table 303 from 4096 to 256.

Viewability of a graph and accuracy of presentation information have a trade-off relation. Consequently, the user can select display of all of classes or display of consolidated classes depending on the situation. For example, the user views the presented graph once and, after that, can give an instruction to start changing a classification definition including designation of changing a range of indication values.

### Eighth Embodiment

### Division of Ability States

In the beginning from start of operation of the advice presentation server 3, by performing classification in the smaller number of ability classes by using the class consolidating method according to the seventh embodiment and presenting a graph obtained by coupling graphs obtained by training in the ability classes, the operation is performed effectively. It is, however considered that, with increase in the amount of data (particularly, the exercise measurement result 22) stored in the database, the user asking for advice has to discriminate the detailed differences in records of users whose ability is close to the user and abilities among users classified in the same ability class.

In the eighth embodiment, there is further provided a dividing unit, when the number of users belonging to any of the plurality of ability states stored in the storing unit is equal to or larger than predetermined number, which divides a range of abilities of users belonging to an ability state in which the number of users is equal to or larger than the predetermined number to obtain new two or more ability states. The selecting unit performs the selection by using the divided ability states. By dividing the range of ability classes as described above, accurate and subdivided advice in which the ability state of an individual is reflected more can be presented. Description of parts similar to those in the third embodiment will not be repeated. For example, since the configuration of the advice presentation server 3 is similar to that in the third embodiment described with reference to FIG. 6 in the fourth embodiment, the description will not be repeated.

An example of means for realizing the above is as follows. Each time the exercise measurement result 22 of the user to ability classes by the classifying unit 32, the advice presentation server 3 stores a classification result into the HDD 105 or the like. The advice presentation server 3 analyzes the classification result at a predetermined opportunity, totals the number of users belonging (classified) to each of ability classes, and determines whether an ability class in which the number of users is equal to or larger than a predetermined number exists or not. The advice presentation server 3 divides the range of evaluation values defined in the ability class in which the number of users is equal to or larger than the predetermined number into a plurality of ranges and updates the item evaluation table 302 and the classification table 303 each having two or more evaluation values. After that, the advice presentation server 3 generates and displays the advice graph 23 by using the updated item evaluation table 302 and the updated classification table 303.

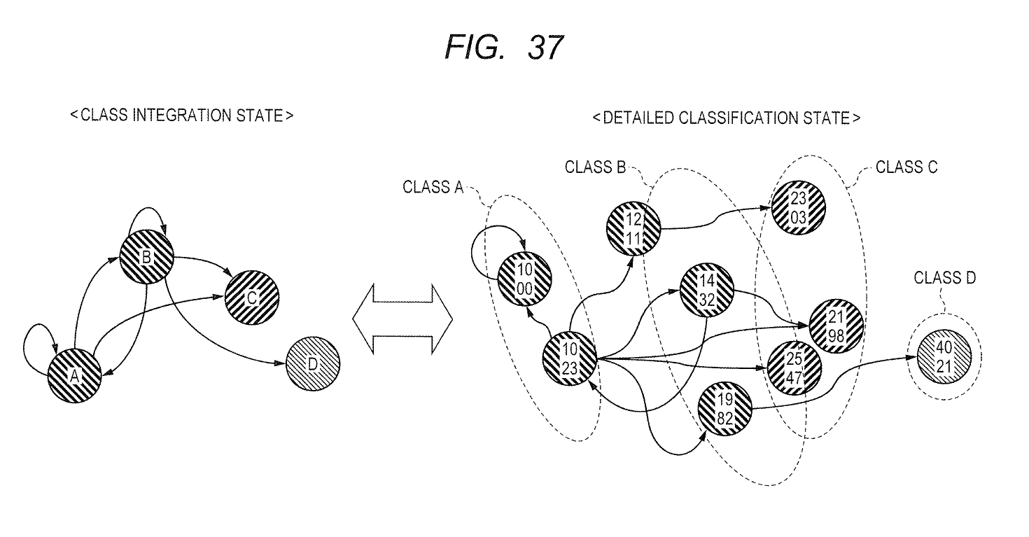

FIG. 37 is a diagram for explaining the concept in a class integration state according to the seventh embodiment and a detailed classification state according to the eighth embodiment. In the beginning after start of operation of the advice presentation server 3, a graph is displayed in the class integration state. As the number of pieces of registration data increases, a graph is displayed in the detailed classification state. Consequently, viewability of graphs and accuracy of presentation information can be maintained at constant level. Further, in the case where a graph is displayed once in the detailed classification class and, after that, the number of users belonging to a part of ability classes does not increase, the ability classes having small number of users may be integrated and a class integration state can be used partially.

### Other Embodiments

Although the present invention has been described as the configuration of hardware in the foregoing embodiments, the present invention is not limited to the above. In the present invention, arbitrary processes can be realized by making a CPU (Central Processing Unit) execute a computer program.

In the above example, a program can be stored by using a non-transitory computer readable medium of various types and supplied to a computer. The non-transitory computer readable medium include a tangible storage medium of various types. Examples of the non-transitory computer readable medium include a magnetic recording medium (for example, a flexible disk, a magnetic tape, or a hard disk drive), a magneto-optic recording medium (for example, a magneto-optical disk), a CD-ROM (Read Only Memory), a CD-R, a CD-R/w, a DVD (Digital Versatile Disc), a BD (Blu-ray (registered trademark) Disc), and a semiconductor memory (for example, a mask ROM, a PROM (Programmable ROM), an EPROM (Erasable PROM), a flash ROM, and a RAM (Random Access Memory)). A program may be supplied to a computer by a transitory computer readable medium of various types. Examples of the transitory computer readable medium include an electric signal, an optical signal, and an electromagnetic wave. The transitory computer readable medium can supply a program to a computer via a wire communication path such as an electric line or an optical fiber or a wireless communication path.

The embodiment can be also expressed as follows.

A program making a computer execute:

a process of storing, into a storing device, state transition information in which at least one ability improving method executed by each of a plurality of registered users and a combination of transitions of ability states of the plurality of registered users by execution of at least apart of the ability improving method are associated;

a process of selecting at least one second ability state which is an after-transition state from a first ability state in a trial user aiming at reaching a desired ability state and can be a pass point to the desired ability state; and

a process of generating between-ability-state relative position information including a relative position relation using the first ability state as a reference and the associated ability improving method for each of the selected at least one second ability state.

Although the present invention achieved by the inventors herein has been concretely described on the basis of the embodiments, obviously, the invention is not limited to the above-described embodiments but can be variously changed without departing from the gist.

What is claimed is:

1. An information processing apparatus comprising:
a storing unit storing state transition information in which at least one ability improving method executed by a plurality of registered users and a combination of transitions of ability states of the registered users by execution of at least a part of the ability improving method are associated;
a selecting unit selecting, from the state transition information, at least one second ability state which is an after-transition state from a first ability state in a trial user aiming at reaching a desired ability state and can be a pass point to the desired ability state; and
a generating unit generating between-ability-state relative position information including a relative position relation using the first ability state as a reference and the associated ability improving method, for each of the selected at least one second ability state.

2. The information processing apparatus according to claim 1,
wherein the selecting unit selects the two or more second ability states, and
wherein the generating unit generates the between-ability-state relative position information including the difference of abilities between the selected two or more ability states as the relative position relation.

3. The information processing apparatus according to claim 1,
wherein the storing unit also stores characteristic information corresponding to the ability improving method, and
wherein the generating unit generates the between-ability-state relative position information including the relative position relation according to characteristic information corresponding to the ability improving method.

4. The information processing apparatus according to claim 3,
wherein the ability state is expressed by position coordinates in a predetermined coordinate system, and
wherein the generating unit generates the between-ability-state relative position information as a directed graph indicating the transition by a directed link from the position coordinates corresponding to the first ability state to the position coordinates corresponding to the selected at least one second ability state according to the characteristic information corresponding to the associated ability improving method.

5. The information processing apparatus according to claim 3,
wherein the desired ability state corresponds to any of a plurality of ability states aimed by the trial user to achieve a predetermined goal, and
wherein the ability state is a set of indication values in a plurality of indices related to the goal.

6. The information processing apparatus according to claim 5,
wherein the generating unit calculates a first score by predetermined conversion from the set of the index values in the first ability state,
determines position coordinates in a predetermined coordinate system with respect to the first ability state on the basis of the first score,
calculates a second score by the predetermined conversion from a set of index values in each of the selected at least one second ability state,
determines position coordinates in the predetermined coordinate system with respect to the selected at least one second ability state on the basis of the second score and the characteristic information corresponding to the transition, and
generates the between-ability-state relative position information on the basis of the determined position coordinates.

7. The information processing apparatus according to claim 1, further comprising an updating unit, when an input on an ability state after the trial user executes the ability improving method is received from the trial user, updating the state transition information in which the set of the transitions using the first ability state as a before-transition ability state and the input ability state as the after-transition ability state is associated with the ability improving method executed.

8. The information processing apparatus according to claim 3,
wherein the characteristic information includes a plurality of kinds of sub-characteristics, and
wherein the generating unit generates the between-ability-state relative position information in accordance with designation of priority of the sub-characteristic from the trial user.

9. The information processing apparatus according to claim 1,
wherein the ability state is expressed by position coordinates in a predetermined coordinate system,
wherein the selecting unit specifies an ability state within a predetermined range from the position coordinates corresponding to the ability state of the trial user and further selects the second ability state as the after-transition ability state in the case where the specified ability state is set as the first ability state on the basis of the state transition information, and
wherein the generating unit generates the between-ability-state relative position information by including the further selected second ability state.

10. The information processing apparatus according to claim 1,
wherein the desired ability state corresponds to any of a plurality of ability states aimed by the trial user to achieve a predetermined goal,
wherein the goal is a threshold in a specific index, and
wherein the ability state is a set of a plurality of indication values as a breakdown of the specific index.

11. The information processing apparatus according to claim 1,
wherein the storing unit stores a plurality of pieces of the state transition information according to attributes related to the body of a user, and
wherein when an input of the attribute of the trial user is received, the selecting unit selects the state transition information according to the attribute and selects at least one second ability state on the basis of the selected state transition information.

12. The information processing apparatus according to claim 1,
wherein the desired ability state corresponds to any of a plurality of ability states aimed by the trial user to achieve a predetermined goal,
wherein the storing unit further stores:
a plurality of index values in indices corresponding to abilities of the registered users and related to the goal; and
a predetermined classification definition for classifying the users to the ability states from the index values,
wherein an integrating unit is further provided which integrates a part of the ability states by changing the predetermined classification definition in accordance with designation from the outside or a result of analysis of the index values at a predetermined timing, and
wherein the selecting unit applies the changed classification definition to each of the index values to classify each of the registered users to any of the ability states integrated, and
performs the selection using the ability states to which the registered users are classified as the second ability state.

13. The information processing apparatus according to claim 7, further comprising a dividing unit, in the case where the number of users belonging to any of the ability states stored in the storing unit is equal to or larger than predetermined number, dividing a range of abilities of a user belonging to the ability state in which the number of users is equal to or larger than the predetermined number to set new two or more ability states,
wherein the selecting unit performs the selection by using the divided ability states.

14. An ability improvement assisting method comprising:
storing state transition information in which at least one ability improving method executed by a plurality of registered users and a combination of transitions of ability states of the registered users by execution of at least a part of the ability improving method are associated into a storing device;
selecting, from the state transition information, at least one second ability state which is an after-transition state from a first ability state in a trial user aiming at reaching a desired ability state and can be a pass point to the desired ability state; and
generating between-ability-state relative position information including a relative position relation using the first ability state as a reference and the associated ability improving method, for each of the selected at least one second ability state.

15. An information processing apparatus comprising:
a storing unit storing state transition information in which a plurality of after-transition ability states indicating states of abilities changed by execution of at least a part of a plurality of ability improving methods from a before-transition ability state of each of a plurality of registered users and a combination of the ability improving methods executed in the transition are associated; and
a generating unit, when an ability state of a trial user corresponds to the before-transition ability state, generating between-ability-state relative position information including a relative position relation using the before-transition ability state as a reference for each of the after-transition ability states and the associated ability improving method.
